(19) United States
(12) Patent Application Publication
(10) Pub. No.: US 2026/0036466 A1
(43) Pub. Date: Feb. 5, 2026

(54) METHODS AND SYSTEMS FOR INTEGRATING-SPHERE-ASSISTED RESONANCE SYNCHRONOUS (ISARS) SPECTROSCOPY

(71) Applicant: Mississippi State University, Mississippi State, MS (US)

(72) Inventors: Dongmao Zhang, Starkville, MS (US); Max WAMSLEY, Mississippi State, MS (US)

(73) Assignee: Mississippi State University, Mississippi State, MS (US)

(21) Appl. No.: 18/998,097

(22) PCT Filed: Jul. 25, 2023
(86) PCT No.: PCT/US2023/028563

§ 371 Date: Jan. 23, 2025

Related U.S. Application Data
(60) Provisional application No. 63/392,148, filed on Jul. 26, 2022.

(51) Int. Cl. G01J 3/02; G01J 3/42; G01J 3/44; G01N 21/25; G01N 21/31

(52) U.S. Cl. CPC G01J 3/0254; G01J 3/42; G01J 3/4406; G01N 21/255; G01N 21/31; G01N 2021/3129; G01N 2201/065

(57) ABSTRACT

The present disclosure provides an integrating-sphere-assisted resonance synchronous (ISARS) spectroscopy method performed with an ISARS spectrophotometer, for example, a spectrofluorometer equipped with an integrating-sphere accessory. The methods and systems of the present disclosure utilize the ISARS spectrophotometer equipped with an integrating sphere to determine the ISARS spectral intensity, quantify the ISARS-based absorbance, and subsequently evaluate the sample's double-beam UV-vis absorbance spectrum (also known as the absorption extinction spectrum). This ISARS method enables quantitative separation of light absorption and scattering contribution to the sample UV-vis extinction spectrum measured with double-beam UV-vis spectrophotometer.

### CROSS-REFERENCE TO RELATED APPLICATIONS

This application is a national stage application, filed under 35 U.S.C. § 371, of International Patent Application No. PCT/US23/28563, filed on Jul. 25, 2023, which claims the benefit of and priority to U.S. Provisional Application No. 63/392,148, filed on Jul. 26, 2022, and entitled “Integrating-Sphere-Assisted Resonance Synchronous (ISARS) Spectroscopy Method,” the disclosure of which is expressly incorporated by reference in its entirety.

### TECHNICAL FIELD

The present invention relates generally to spectroscopy methods, and more particularly, to integrating-sphere-assisted resonance synchronous (ISARS) spectroscopy methods and systems performed with a spectrophotometer, such as a spectrofluorometer equipped with an integrating-sphere accessory.

### BACKGROUND

Ultraviolet-visible-near infrared (UV-vis-NIR) spectrophotometry is a widely used method in the chemical, biological, and materials sciences for its high reproducibility and affordability. UV-vis-NIR spectrophotometry measures the total light extinction or light loss through a sample. That is, both light absorption and light scattering are measured as a summation which, in turn, provides the UV-vis-NIR extinction spectra. However, quantitative decoupling of the light scattering and absorption contribution to the sample UV-vis-NIR extinction spectrum can be challenging for complex materials that both scatter and absorb light. It has remained a prevalent practice to directly take the UV-vis extinction spectra as the absorbance spectra even for nanoparticle samples that likely have a significant scattering extinction. This, however, often leads to spectral misinterpretation.

Light scattering is a universal material property with light scattering contribution increasing with size. For dissolved small molecular chromophores, the scattering contribution to the sample UV-vis extinction is negligible because the scattering coefficients of these samples are usually drastically smaller than their absorption coefficients. However, for macromolecules, supramolecules, and nanoscale materials, the scattering contribution to the sample extinction UV-vis can be significant and must be considered during analysis. Reliable quantification of the scattering and absorption activities is critical for materials designs and applications because scattering and absorption differ fundamentally both in their causes and effects. Absorption is typically useful for photovoltaic applications, fluorescence signaling, photodynamic therapy, and photocatalysis, while materials with high scattering activity can be used for applications such as intracellular imaging and UV light blocker for sunscreen. Separating materials' light absorption and scattering contribution to their UV-vis spectra is also necessary for reliable chemical measurements.

Several approaches have been explored for decomposing UV-vis extinction spectra of solutions into their absorbance and scattering extinction spectra. However, the accessibility and reliability of those methods to general samples is limited. For example, the method developed by Lin et al. simultaneously detected the transmitted and 90-degree propagated photons using a home-developed fiber-coupled spectrometer (Analytical Chemistry 2015, 87, 1058-1065). However, this method is only applicable to nonfluorescent samples. Additionally, the method did not consider the inner filter effect on light scattering induced by the light absorption or the effect of light scattering depolarization on the signal detection. Similarly, while the resonance synchronous spectroscopic approach considers the interplay among the sample absorption and scattering, the effects of scattering depolarization and sample on-resonance fluorescence are not considered and can interfere with the signal (Collings et al., The Journal of Physical Chemistry B 1999, 103, 8474-8481).

Integrating spheres (IS) have long been used to obtain the absorbance spectra of turbid solutions, solid materials, and even for single particles. Existing IS-based absorbance quantification is performed mostly with UV-vis spectrophotometers or similar instruments equipped with an excitation monochromator but with no detection monochromator. These approaches are susceptible to fluorescence and Raman interferences that can be from the sample, solvents, and the integrating sphere itself. The fluorescence and Raman interference is negligible in the double-beam UV-vis measurements because of the spatial selectivity of the detector in the spectrophotometer. However, fluorescence emission and Raman signal triggered inside and by the IS inevitably leads to underestimated IS-based absorbance that uses the spectrophotometer as the detector. The latter occurs due to the IS capturing all fluorescence and Raman photons with no spatial selectivity. Another problem with the existing IS-based approach is the lack of consideration of the instrument dark background signal in the calculation of the sample light absorbance inside the IS.

IS-equipped UV-vis spectrophotometers are also commercially available. These instruments are generally configured such that the sample is placed outside the integrating sphere. Compared to home-built IS-equipped spectrophotometers with the cuvette placed inside the IS, the configuration adopted by these commercial spectrophotometers reduces the fluorescence interference because only the forward propagating fluorescence photons can lead to falsely low absorbance extinction. However, it will drastically enhance the susceptibility to scattering interference because this configuration captures only the forwardly propagated scattering photons in the absorbance determination. As a result, the scattered photons propagated in the other directions leads to overestimated sample absorbance.

Accordingly, there remains a need in the art for improved methods and systems to easily decompose UV-vis extinction spectra into their absorbance and scattering extinction spectra.

### SUMMARY

The problems expounded above, as well as others, are addressed by the following inventions, although it is to be understood that not every embodiment of the inventions described herein will address each of the problems described above. The present disclosure provides integrating-sphere-assisted resonance synchronous (ISARS) spectrophotometric technology for quantification of materials' light absorption and scattering activities for samples that contain, for instance, nanoscale or larger materials. The present disclosure includes devices, methodology, accessories, and reagents for the technology implementation.

In some embodiments, an integrating-sphere-assisted resonance synchronous (ISARS) spectrophotometer is provided, the ISARS spectrophotometer including a light source, an excitation monochromator configured to separate light from the light source and output a selected excitation wavelength (λₓ) of the excitation light, an integrating sphere having an inner surface configured to diffuse reflect light reaching the surface, a detection monochromator configured to receive light exiting the integrating sphere and output a selected detection wavelength (λ_{d}) of the exit light, wherein the excitation wavelength (λₓ) and the detection wavelength (λ_{d}) are substantially the same and varied simultaneously over a wavelength region, and a detector configured to detect the light from the detection monochromator.

In one embodiment, the integrating sphere includes a sample positioned therein. In another embodiment, the detector is configured to acquire an ISARS intensity spectrum of the sample. In still another embodiment, the integrating sphere has an inner diameter ranging from about 4 cm to about 50 cm. In yet another embodiment, the ISARS spectrophotometer further includes an excitation neutral density filter, a detection neutral density filter, or a combination of both for adjusting the excitation or detection light intensity.

In further embodiments, an ISARS spectroscopy system for measuring a double-beam absorption spectrum of a sample is provided, the ISARS spectroscopy system including an ISARS spectrophotometer including a light source, an excitation monochromator configured to separate light from the light source and output a selected excitation wavelength (λₓ) of the excitation light, an integrating sphere having an inner surface configured to diffuse scatter the light, wherein the integrating sphere includes the sample positioned therein, a detection monochromator configured to receive light exiting the integrating sphere and output a selected detection wavelength (λ_{d}) of the exit light, wherein the excitation wavelength (λₓ) and the detection wavelength (λ_{d}) are substantially the same and varied simultaneously over a wavelength region, a detector configured to detect the exit light and acquire an ISARS intensity of the sample, and a processor operatively connected to the ISARS spectrophotometer, wherein the processor includes a non-transitory computer readable medium with instructions executable to: calculate an ISARS-based absorbance spectrum from the ISARS intensity of the sample and convert the ISARS-based absorbance spectrum into the double-beam absorption spectrum.

In some embodiments, the sample is a fluorescent solution including a nanoscale material or macromolecule. In another embodiment, the sample is a nonfluorescent solution including a nanoscale material or macromolecule. In still another embodiment, the sample is a solid powder or a film having a thickness from about 100 nm to 2 cm. In yet another embodiment, the detection monochromator is configured to receive the exit light from an exit port of the integrating sphere, wherein the exit port is placed at an angle from about 10 degrees to about 170 degrees with respect to a direction of incidence of the excitation light. In another embodiment, the sample is positioned in the integrating sphere at an angle of about 5 degrees to about 85 degrees relative to the incident beam. In still another embodiment, the integrating sphere further includes one to three baffles positioned therein.

In still further embodiments, a method for determining a baseline of the ISARS spectrophotometer described herein is provided, the method including acquiring, with the ISARS spectrophotometer, an ISARS baseline spectra of a baseline sample, wherein the baseline sample is a saturated light absorbing sample. The baseline sample may include potassium permanganate (KMnO₄), copper (II) nitrate (Cu(NO₃)₂), nickel sulfate (NiSO₄), carbon-based particle dispersants, or other strong light-absorbing reagents. In another embodiment, the baseline sample is a saturated or near saturated solution. In still another embodiment, the ISARS baseline spectra are used in a wavelength region where the baseline sample's ISARS intensity does not change with a dilution of the saturated sample.

In yet further embodiments, a method for calibrating the ISARS spectrophotometer described herein is provided, the method including acquiring, with the ISARS spectrophotometer, ISARS-based absorbance spectra A_{ISARS}(λ) of a series of calibration samples, wherein the calibration samples include a plurality of solutions of molecular chromophores. In one embodiment, the molecular chromophores are pure light absorbers having no significant scattering activity. In another embodiment, the molecular chromophores are selected from the group consisting of potassium permanganate (KMnO₄), copper (II) nitrate (Cu(NO₃)₂), nickel sulfate (NiSO₄), and combinations thereof. In still another embodiment, the method includes acquiring double-beam UV-vis spectra of the calibration samples, A_{db} (λ), and curve-fitting the ISARS-based absorbance spectra A_{ISARS}(λ) to the double-beam UV-vis spectra according to the following equation:

$${A}_{db} ( λ ) = {a}_{3} ( λ ) {( {A}_{ISARS} ( λ ) )}^{3} + {a}_{2} ( λ ) {( {A}_{ISARS} ( λ ) )}^{2} + {a}_{1} ( λ ) {A}_{ISARS} ( λ ) + {a}_{0} ( λ ) .$$

In further embodiments, a method for decomposing a double-beam UV-vis extinction spectrum is provided, the method including acquiring, with a UV-vis spectrophotometer, the double-beam UV-vis extinction spectrum of the sample; acquiring, with an ISARS spectrophotometer, an ISARS intensity spectrum of the sample; transmitting the measured double-beam extinction spectrum and the ISARS intensity spectrum to a processor, wherein the processor includes a non-transitory computer readable medium with instructions executable to: convert the ISARS intensity spectrum into an ISARS-based absorbance spectrum, determine an ISARS-based double-beam absorbance spectrum from the ISARS-based absorbance spectrum, and determine an ISARS-based double-beam scattering extinction spectrum from the ISARS-based double-beam absorbance spectrum and the double-beam UV-vis extinction spectrum.

In some embodiments, the ISARS-based double-beam scattering extinction spectrum is determined by subtracting the ISARS-based double-beam absorbance spectrum from the double-beam UV-vis extinction spectrum. In another embodiment, the ISARS intensity spectrum is converted by determining a baseline ISARS intensity spectrum and calculating ISARS-based absorbance spectrum according to the following equation:

$${A}_{ISARS} ( λ ) = - log \frac{{I}_{ISARS , sample} ( λ ) - {I}_{ISARS , baseline} ( λ )}{{I}_{ISARS , solvent} ( λ ) - {I}_{ISARS , baseline} ( λ )}$$

where I_{ISARS, sample}(λ) is the ISARS intensity spectrum of the sample, I_{ISARS, baseline}(λ) is the baseline ISARS intensity spectrum, and I_{SARS, solvent}(λ) is an ISARS intensity spectrum of a solvent control. In still another embodiment, the ISARS-based double-beam absorbance spectrum is related to the ISARS-based absorbance spectrum according to the following equation:

$${A}_{db}^{ISARS} ( λ ) = {a}_{3} ( λ ) {( {A}_{ISARS} ( λ ) )}^{3} + {a}_{2} ( λ ) {( {A}_{ISARS} ( λ ) )}^{2} + {a}_{1} ( λ ) {A}_{ISARS} ( λ ) + {a}_{0} ( λ )$$

where

$${A}_{db}^{ISARS}$$

is the ISARS-based double-beam absorbance spectrum, A_{ISARS} is the ISARS-based absorbance spectrum, and a₀, a₁, a₂, and a₃ are polynomial fitting coefficients obtained with ISARS calibration samples.

### BRIEF DESCRIPTION OF THE DRAWINGS

Further features and advantages can be ascertained from the following detailed description that is provided in connection with the drawings described below:

FIG. 1 is a schematic illustration of a system for integrating-sphere-assisted resonance synchronous (ISARS) spectral acquisition performed in accordance with one embodiment of the present disclosure.

FIG. 2A is an ISARS spectra of an empty integrating sphere (IS), a cuvette with water, and a cuvette with KMnO₄ at indicated concentrations.

FIG. 2B is an enlarged ISARS spectra of KMnO₄.

FIG. 2C shows ISARS intensity as a function of KMnO₄ at three representative wavelengths.

FIGS. 2D and 2E are ISARS spectra of Cu(NO₃)₂ at the indicated concentrations.

FIG. 2F is an ISARS baseline spectrum determined with saturated or near saturated KMnO₄ and Cu(NO₃)₂.

FIG. 3A is a UV-vis spectra of approximately 12 mM NiSO₄ showing that it has relatively high absorptivity from 330 nm to 450 nm and from 600 nm to 800 nm.

FIG. 3B is an ISARS spectra of NiSO₄ at its saturation and near saturated concentration. The inset shows NiSO₄ ISARS intensity at three representative wavelengths as a function of NiSO₄ concentration.

FIG. 3C is an overlayer of baseline spectra obtained with KMnO₄, Cu(NO₃)₂ and NiSO₄.

FIG. 4A shows the ISARS intensity obtained with a series of saturated or near-saturated KMnO₄ solutions having a volume of 3.5 mL.

FIG. 4B shows the ISARS intensity obtained with a series of saturated or near-saturated KMnO₄ solutions having a volume of 3.0 mL.

FIG. 4C shows the ISARS intensity obtained with a series of saturated or near-saturated KMnO₄ solutions having a volume of 2.5 mL.

FIG. 4D shows the ISARS intensity obtained with a series of saturated or near-saturated KMnO₄ solutions having a volume of 2.0 mL.

FIG. 5A is a double-beam UV-vis spectra A_{db}(λ) of the KMnO₄ solutions.

FIG. 5B is a baseline corrected ISARS spectra of the solvent and KMnO₄.

FIG. 5C is an ISARS-derived UV-vis absorbance spectra A_{ISARS}(λ) of the KMnO₄.

FIGS. 5D and 5E show experimental (dots) and curve-fitting correlation (solid line) between A_{db}(λ) and A_{ISARS}(λ) for two representative wavelengths. One standard deviation of A_{ISARS}(λ) is shown as the shades.

FIG. 5F is an example third-order polynomial fitting of the A_{db}(λ) intensity as a function of A_{ISARS}(λ) of the KMnO₄ calibration solutions. The fitted data is generated using Eq. 1 using the Aₛ(λ), r(λ), and f(λ) values shown in FIG. 5D and with the A_{db}(λ) varying from 0.01 to 2.5 with the step value of 0.01.

FIG. 6A shows a double-beam UV-vis spectra A_{db}(λ) of the NiSO₄ solutions.

FIG. 6B shows a baseline corrected ISARS spectra of the solvent and NiSO₄.

FIG. 6C shows the ISARS-derived UV-vis absorbance spectra A_{ISARS}(λ) of the NiSO₄.

FIGS. 6D-6F show experimental (dots) and curve-fitting correlation (solid line) between A_{db}(λ) and A_{ISARS}(λ) for three representative wavelengths. One standard deviation of A_{ISARS}(λ) is shown as the shades.

FIG. 7A is a double-beam UV-vis spectra A_{db}(λ) of the concentrated NiSO₄ solutions.

FIG. 7B is a baseline corrected ISARS intensity spectra of the solvent and NiSO₄.

FIG. 7C is an ISARS-based UV-vis absorbance spectra A_{ISARS}(λ) of the NiSO₄.

FIG. 7D shows experimental (dots) and curve-fitting correlation (solid line) between A_{db}(λ) and A_{SARS}(λ) for an example wavelength of 450 nm obtained with the calibration sample, NiSO₄

FIG. 8 shows Aₛ(λ), r(λ), and f(λ) as a function of the ISARS excitation wavelength evaluated with the (black) KMnO₄ and (red) NiSO₄.

FIG. 9A shows fluorescence emission spectra obtained with the same empty cuvette with and without the IS.

FIG. 9B shows fluorescence emission spectra obtained with the same water-in-cuvette samples with and without integrating sphere. The cuvette was essentially background free as it can be seen from the spectra obtained with the empty cuvette and water samples but with no IS. Therefore, the high background seen in the spectra obtained with the IS is from the IS background fluorescence and/or excitation source stray light interference.

FIG. 10A shows fluorescence emission spectra of ultrapure barium sulfate and water. Note the scale of the data for BaSO₄ is 100-fold higher than that for water. The sharp peaks in the BaSO₄ and water fluorescence spectra are the Raman peak of SO₄²- stretching (approximately 1000 cm⁻¹) and water (0-H) stretching peak (approximately 3300 cm⁻¹). The broad and intense background indicates the even the ultrapure BaSO₄ contains fluorescence impurities.

FIG. 10B shows experimental BaSO₄ extinction spectrum (black), the ISARS-based BaSO₄ absorbance (red), and the deduced double-beam absorbance of BaSO₄ (blue).

FIG. 11A is a baseline corrected ISARS spectra of the solvent and Rhodamine 6G (R6G) of different concentrations with a monochromator slit width of 1 nm.

FIG. 11B is a baseline corrected ISARS spectra of the solvent and R6G of different concentrations with a monochromator slit width of 2 nm.

FIG. 11C is a baseline corrected ISARS spectra of the solvent and R6G of different concentrations with a monochromator slit width of 4 nm.

FIG. 11D is an ISARS-based UV-vis absorbance spectra calculated using the ISARS spectra of FIG. 11A.

FIG. 11E is an ISARS-based UV-vis absorbance spectra calculated using the ISARS spectra of FIG. 11B.

FIG. 11F is an ISARS-based UV-vis absorbance spectra calculated using the ISARS spectra of FIG. 11C.

FIG. 11G is a head-to head comparison of the measured (dash line) and deduced (solid line) double-beam UV-vis absorbance spectra from the ISARS-based UV-vis spectra of FIGS. 11A and D.

FIG. 11H is a head-to head comparison of the measured (dash line) and deduced (solid line) double-beam UV-vis absorbance spectra from the ISARS-based UV-vis absorbance spectra of FIGS. 11B and E.

FIG. 11I is a head-to head comparison of the measured (dash line) and deduced (solid line) double-beam UV-vis absorbance spectra from the ISARS-based UV-vis absorbance spectra of FIGS. 11C and F.

FIG. 12A is a UV-vis spectrum of R6G obtained with the double-beam Shimazu UV-vis spectrophotometer with (A_{ISUV}) and without (A_{db}) its IS-accessory. The lower absorbance observed in R6G A_{ISUV} spectrum than its A_{db} spectrum is due to the fluorescence interference.

FIG. 12B is a UV-vis spectrum of KMnO₄ obtained with the double-beam Shimazu UV-vis spectrophotometer with (A_{ISUV}) and without (A_{db}) its IS-accessory.

FIG. 13A is a baseline corrected ISARS intensity spectra of solvent water and polystyrene nanoparticles (PSNPs).

FIG. 13B is a baseline corrected ISARS intensity spectra of solvent water and fluorescent polystyrene nanoparticles (fPSNPs).

FIG. 13C is a baseline corrected ISARS intensity spectra of solvent water and QDs.

FIGS. 13D-13F show a comparison of the total ISARS-derived double-beam absorption and scattering extinction spectra obtained with PSNP, QDs, and fPSNP.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The term “spectrophotometer” refers to a device that measures light intensity as a function of the wavelength of the electromagnetic radiation.

The term “integrating-sphere-assisted resonance synchronous (ISARS) spectrophotometer” refers to a spectrofluorometer that can be configured for an ISARS measurement or any other instrument designed specifically for ISARS measurement.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first,” “second,” “third,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The present disclosure provides an integrating-sphere-assisted resonance synchronous (ISARS) spectroscopic system, reagents, and methods for quantifying the UV-vis absorbance of samples ranging from pure absorbers and pure scatterers to simultaneous light absorbers, scatterers, and emitters. The methods, reagents, and systems of the present disclosure utilize a spectrophotometer equipped with an integrating sphere to determine the ISARS spectral intensity, quantify the ISARS-based absorbance, and subsequently evaluate the sample's double-beam UV-vis absorbance spectrum (also known as the absorption extinction spectrum). The ISARS methods and systems of the present disclosure may be used with samples, including, for instance, fluorescent or non-fluorescent solutions including a nanoscale material or macromolecule, solid powders, or films having a thickness ranging from about 100 nm to about 2 cm.

In some embodiments, the method of the present disclosure includes a baseline quantification step that determines the ISARS intensity for baseline samples. In one embodiment, the baseline samples are saturated or near saturated optically dense absorbing samples. The baseline ISARS intensity is approximately the minimum ISARS intensity that can be obtained with an ISARS spectrophotometric instrument. In further embodiments, the method of the present disclosure includes an ISARS-based absorbance quantification step that calculates the ISARS absorption using the sample, solvent, and baseline ISARS intensity spectra. In still further embodiments, the method of the present disclosure includes a calibration step that establishes the correlation between the ISARS-based absorbance with the sample double-beam UV-vis absorbance. In yet further embodiments, the method of the present disclosure includes calculating, using the sample ISARS-based absorbance spectrum, the double-beam absorbance spectrum using the calibration described above. For samples where the double-beam UV-vis extinction spectrum is available with UV-vis spectrophotometric measurement, the ISARS-derived double-beam absorbance can be used for quantification of the sample's double-beam light scattering extinction spectrum. Using the methods and systems described herein, the sample's UV-vis extinction spectra acquired with the UV-vis spectrophotometers can more accurately be decomposed into absorbance and scattering extinction spectra.

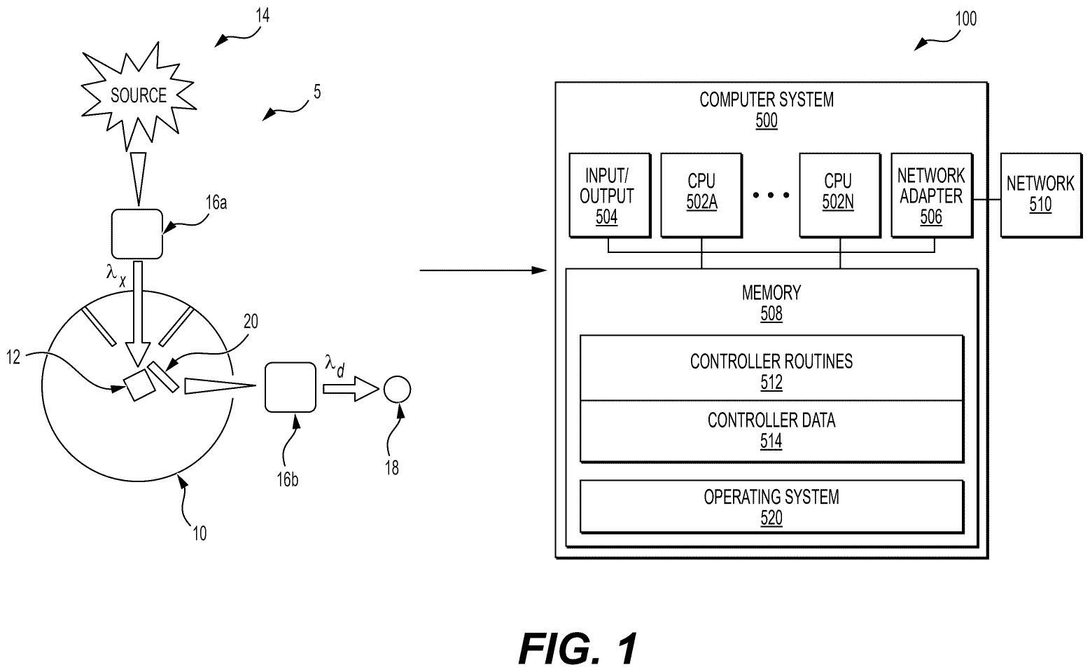

Referring to FIG. 1, a schematic illustration of a system 100 for use with the present disclosure is shown. The system 100 includes a spectrophotometer equipped with an integrating sphere to perform integrating-sphere-assisted resonance synchronous (ISARS) spectral acquisition in accordance with the present disclosure, hereinafter referred to as an ISARS spectrophotometer 5. During the ISARS data acquisition, the excitation wavelength (λₓ) and detection wavelength (λ_{d}) are kept the same (resonance) and varied simultaneously (synchronous), as depicted in FIG. 1. That is, ISARS spectra are acquired wavelength-by-wavelength under resonance excitation and detection conditions (λₓ=λ_{d}) crossing the entire wavelength region.

The ISARS spectrophotometer 5 is equipped with an integrating sphere 10 that includes a substantially spherical cavity having a highly reflective surface. A highly reflective white material, for example, barium sulfate and polytetrafluoroethylene (PTFE), can be applied on the inner surface of the integrating sphere 10. The integrating sphere 10 includes a sample holder 12 that is configured to hold a sample to be measured. For example, the sample holder 12 may be a cuvette holder. The sample holder 12 is configured to be removable from the integrating sphere 10. The integrating sphere 10 also includes a baffle 20 positioned near the sample holder 12. The baffle 20 is configured to prevent light interchange between the integrating sphere components and regions such as entrance/exit ports, sample, reference, and detector field-of-view.

The ISARS spectrophotometer 5 also includes a light source 14 configured to provide broadband light and two monochromators—an excitation monochromator 16a and a detection monochromator 16b. In some embodiments, the light source 14 is a flash lamp, which generates an excitation light along an excitation light path. In further embodiments, the light source 14 may be any other light source known to those of ordinary skill in the art. In still further embodiments, the light source 14 may be in an application cartridge, which may be configured to direct the excitation light directly to the sample and light exited from the sample to be measured may be directed to a selected detector.

The excitation monochromator 16a is configured to separate light from the light source and transmit a wavelength specific to the excitation spectrum of the sample. In some embodiments, the excitation monochromator 16a is configured to output a selected excitation wavelength (λₓ) of the excitation light generated by the excitation monochromator 16a. The excitation wavelength is represented by λₓ in FIG. 1. The detection monochromator 16b is configured to minimize Raman scattering and emission light before it reaches a detector 18. The detector 18 is configured to detect and measure the light at the resonance wavelength ((λₓ=λ_{d}) and acquire an ISARS-based spectrum. As shown in FIG. 1, the light source 14, the excitation monochromator 16a, and the sample holder 12 are positioned in a linear fashion such that the light from the light source 14 shines directly through the excitation monochromator 16a and the sample contained in the sample holder 12. The detection monochromator 16b is positioned at an angle, for example, at a right angle to the excitation light. In some embodiments, the ISARS spectrophotometer may include an excitation neutral density filter, a detection neutral density filter, or a combination of both for adjusting the excitation or detection light intensity.

In some embodiments, the inner diameter of the integrating sphere 10 may vary from about 4 cm to about 80 cm. In further embodiments, the inner diameter of the integrating sphere 10 may vary from about 4 cm to about 50 cm. In still further embodiments, the inner diameter of the integrating sphere 10 may vary from about 10 cm to about 70 cm. In still further embodiments, the inner diameter of the integrating sphere 10 may vary from about 15 cm to about 60 cm. For example, in some embodiments, the inner diameter of the integrating sphere 10 is about 8 cm.

The integrating sphere 10 may have an incident port and an exit port. In this embodiment, the incident and exit port sizes may vary from about 1 mm to about 30 mm. In some embodiments, the incident and exit port sizes may vary from about 5 mm to about 25 mm. In still further embodiments, the incident and exit port sizes may vary from about 10 mm to about 20 mm. The exit port of the integrating sphere 10 may be placed at an angle of about 10 degrees to about 170 degrees with respect to a direction of incidence of the excitation light. For instance, the exit port of the integrating sphere 10 may be placed at an angle of about 30 degrees to about 120 degrees with respect to a direction of incidence of the excitation light.

In some embodiments, one to three baffles 20 coated with diffuse reflection materials may be placed inside the integrating sphere 10 to minimize the possibility of the direct exit of the incident light and the light reflected from the sample holder surfaces without diffuse reflection by the integrating sphere 10. The sample holder 12, for instance, the cuvette, may be placed inside the integrating sphere 10 in a manner known to those skilled in the art. In one embodiment, the sample holder 12 is positioned in the integrating sphere 10 at an angle of about 5 degrees to about 85 degrees relative to the incident beam. In another embodiment, the sample holder 12 is positioned in the integrating sphere 10 at an angle of about 10 degrees to about 70 degrees.

In operation, the light source 14 shines or sends out light. Before it reaches the sample, the light passes through the excitation monochromator 16a which transmits a selected excitation wavelength (λₓ) of the excitation light while blocking other wavelengths. The excitation light from the excitation monochromator 16a passes into the integrating sphere 10 and through the sample contained in the sample holder 12. The integrating sphere 10 reflects and scatters, on the inner surface, the excitation light that has entered the integrating sphere 10 to irradiate the sample held in the sample holder 12. The light going through or reflected by the sample reaches the inner surface of the integrating sphere 10 and undergoes diffuse reflections. A fraction of the diffuse reflected light by the inner surface of the integrating sphere 10 exits from an exit port of the integrating sphere 10 and is guided to the detection monochromator 16b and the detector 18. The exited light passes through the detection monochromator 16b and the detection monochromator 16b outputs a selected detection wavelength (λ_{d}) of the exit light. The detector 18 measures the exited light and displays the ISARS-based spectrum. As described above, the ISARS technique of the present disclosure acquires ISARS wavelength-by-wavelength under resonance, or the same, excitation and detection conditions (λₓ=λdd) crossing the entire wavelength region.

The system 100 may also include a computer system 500 including one more processors 502A-502N operatively connected to the ISARS spectrophotometer 5. In some embodiments, the processor is configured to calculate an ISARS-based absorbance spectrum from the sample, solvent, and baseline ISARS intensity spectra obtained from the ISARS spectrophotometer 5 and correlate the ISARS-based absorbance spectrum to the UV-vis double-beam absorption spectrum of the sample, as will be explained in more detail below. In further embodiments, the processor can determine the sample's UV-vis double-beam scattering spectrum from the calculated UV-vis double-beam absorption extinction and scattering extinction spectra.

A schematic diagram of the computer system 500 including the one more processors 502A-502N according to one embodiment of the present disclosure is shown in FIG. 1. The computer system 500 may typically be implemented using one or more programmed general-purpose computer systems, such as embedded processors, systems on a chip, personal computers, workstations, server systems, and minicomputers or mainframe computers, or in distributed, networked computing environments. The computer system 500 may include one or more processors (CPUs) 502A-502N, input/output circuitry 504, network adapter 506, and memory 508. CPUs 502A-502N execute program instructions to carry out the functions of the present systems and methods. Typically, CPUs 502A-502N are one or more microprocessors, such as an INTEL CORE® processor.

Input/output circuitry 504 provides the capability to input data to, or output data from, computer system 500. For example, input/output circuitry 504 may include input devices, such as a graphical user interface, keyboards, mice, touchpads, trackballs, scanners, and analog to digital converters; output devices, such as display screens, video adapters, monitors, and printers; and input/output devices, such as modems.

Network adapter 506 interfaces computer system 500 with a network 510. Network 510 may be any public or proprietary data network, such as LAN and/or WAN (for example, the Internet). Memory 508 stores program instructions that are executed by, and data that are used and processed by, CPU 502 to perform the functions of computer system 500. Memory 508 may include, for example, electronic memory devices, such as random-access memory (RAM), read-only memory (ROM), programmable read-only memory (PROM), electrically erasable programmable read-only memory (EEPROM), and flash memory, and electro-mechanical memory, which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, or Serial Advanced Technology Attachment (SATA), or a variation or enhancement thereof, or a fiber channel-arbitrated loop (FC-AL) interface.

Memory 508 may include controller routines 512, controller data 514, and operating system 520. Controller routines 512 may include software routines to perform processing to implement one or more controllers. Controller data 514 may include data needed by controller routines 512 to perform processing. In one embodiment, controller routines 512 may include software for analyzing incoming data from the ISARS spectrophotometer 5 (for example, incoming spectral data). In another embodiment, controller routines 512 may include software for calibrating the ISARS spectrophotometer 5. In still another embodiment, controller routines 512 may include software for analyzing and calculating an ISARS-based absorbance spectrum from the ISARS-based spectrum obtained from the ISARS spectrophotometer 5 and correlating the ISARS-based absorbance spectrum to the UV-vis double-beam absorption spectrum of the sample. In further embodiments, controller routines 512 may include software for analyzing and determining the sample's UV-vis double-beam scattering spectrum from the calculated UV-vis double-beam absorption spectrum.

While the ISARS spectrophotometer demonstrated in FIG. 1 provides an exemplary embodiment for acquiring ISARS spectral data according to the present disclosure, any instrument equipped with an integrating sphere, an excitation monochromator, a detection monochromator, and having the ability to acquire spectra in a resonance synchronous mode can be used for ISARS spectral acquisition in accordance with the present disclosure.

The ISARS spectroscopy system of the present disclosure uses the above-described ISARS spectrophotometer and processor to quantify the double-beam UV-vis absorbance and scattering spectra for samples with different optical complexities. As will be described in more detail below, the present disclosure correlates the sample's ISARS-based and double-beam UV-vis absorbance using a nonlinear three-parameter analytical model and converts the sample's ISARS-based absorbance to its double-beam absorbance and subsequently its double-beam scattering spectrum. The nonlinear three-parameter analytical model is demonstrated by Equation 1:

$${A}_{ISARS} ( λ ) = {A}_{db} ( λ ) + r ( λ ) + log ( \frac{1 - 1 {0}^{- ( {A}_{db} ( λ ) r ( λ ) + {A}_{s} ( λ ) )} ( 1 - f ( λ ) )}{1 - 1 {0}^{- {A}_{s} ( λ )} ( 1 - f ( λ ) )} ) \qquad Eq . 1$$

where A_{ISARS}(λ) is the ISARS absorbance measured with the ISARS spectrophotometer of the present disclosure, A_{db}(λ) is the UV-vis absorbance measured with a conventional UV-vis spectrophotometer, r(λ) is the stepwise light absorption pathlength of the cuvette inside the integrating sphere in the ISARS spectrophotometer of the present disclosure, f(λ) is the sum of the excitation and detection port fractions or the total port fraction of the integrating sphere in the ISARS spectrophotometer of the present disclosure, and Aₛ(λ) is the absorbance by the integrating sphere in the ISARS spectrophotometer of the present disclosure. The systems and methods described herein provide more accurate measurements of the absorption spectrum of samples having optical complexities from approximately pure absorbers, pure scatterers, to simultaneous light absorbers, scatterers, and emitters under resonance excitation and detection conditions.

The ISARS system and method of the present disclosure measures the total light intensity before and after the sample, i.e., the total light lost after shining through the sample in the sample holder 12 within the integrating sphere 10, to determine the absorbance. As such, before determining the sample's ISARS absorbance, a baseline quantification is performed to determine the experimental instrument parameters of Equation 1, including the Aₛ(λ), r(λ), and f(λ) values, and generate a series of polynomial fitting coefficients, as will be described in more detail below. In some embodiments, to determine the baseline and calibrate the ISARS spectrophotometer, the method includes measuring, with the ISARS spectroscopy system 100, an ISARS spectrum of a solvent, such as water, and measuring, with the spectroscopy system 100, an ISARS spectrum of one or more calibration samples. The ISARS-baseline spectrum can be determined using saturated or near-saturated solutions of the calibration sample(s).

In some embodiments, the calibration sample is a sample having intense absorption across abroad wavelength region (for example, 300 nm to 800 nm). The calibration sample should have a double beam UV-vis extinction spectrum that can be approximated as an absorbance spectrum. In one embodiment, the calibration sample may be a molecular chromophore. Suitable molecular chromophores include, but are not limited to, potassium permanganate (KMnO₄), potassium dichromate, copper (II) nitrate (Cu(NO₃)₂), and nickel sulfate (NiSO₄). For example, in one embodiment, the calibration sample is potassium permanganate. In another embodiment, the calibration sample is nickel sulfate. Without being bound by any particular theory, each chromophore was selected because of its high light absorptivity in the entire, or the subset of, interested wavelength range. The effective wavelength ranges of exemplary chromophores are potassium dichromate (150 nm-375 nm), potassium permanganate (350 nm-650 nm), and copper (II) nitrate (650 mm-970 nm). These inorganic, nonfluorescent chromophores cover a wavelength region of 150 nm to 970 nm for baseline correction of the ISARS technique. In still further embodiments, the calibration sample may be a carbon-based particle dispersant or other strong light-absorbing reagent.

One or more saturated or near-saturated solutions of the calibration samples, such as the chromophore solutions, can be used for acquiring the ISARS baseline intensity spectra needed for the ISARS spectral analysis. Saturated or near-saturated solutions of the calibration samples can be formed using techniques known in the art. In some embodiments, the volume of the calibration solutions ranges from about 2.5 mL to about 3.5 mL. For example, the volume of the calibration sample may be about 3.0 mL.

Upon determining the ISARS-baseline spectrum, the ISARS absorbance spectrum of the calibration sample can be quantified using Equation 2 shown below:

$${A}_{ISARS} ( λ ) = - log ( \frac{{I}_{sample}^{ISARS , obsd} ( λ ) - {I}_{B}^{ISARS} ( λ )}{{I}_{solvent}^{ISARS , obsd} ( λ ) - {I}_{B}^{ISARS} ( λ )} ) \qquad Eq . 2$$

where

$${I}_{sample}^{ISARS , obsd} ( λ )$$

is the ISARS intensity of the calibration sample measured above,

$${I}_{solvent}^{ISARS , obsd} ( λ )$$

is the ISARS intensity of the solvent measured above, and I_{B}^{ISARS}(λ) is the ISARS-baseline spectrum measured above. By taking the ratiometric log of the ISARS intensity of the calibration sample and the solvent, Equation 2 quantifies the ISARS absorbance spectrum of the calibration sample.

The method also includes measuring, with a conventional spectrophotometer, a double-beam UV-vis absorbance spectrum of the calibration sample such that the double-beam UV-vis absorbance of the calibration sample (A_{db}(λ)) can be used in Equation 1 above. Any conventional spectrophotometer known in the art may be used to measure the UV-vis spectrum of the calibration sample.

After obtaining the ISARS absorbance spectrum and double-beam UV-vis absorbance spectrum of the calibration sample, the two measurements can be correlated using the three-parameter model shown in Equation 1 above. Equation 1 is also believed to be the first principle-analytical model that takes into consideration the absorbance by the integrating sphere itself. This model shows that the ISARS absorbance, A_{ISARS}(λ), is nonlinearly correlated to the double-beam UV-vis absorbance, A_{db}(λ). Furthermore, by nonlinear fitting of the experimental ISARS absorbance, A_{ISARS}(λ), as a function of the double-beam UV-vis absorbance, A_{db}(λ), the experimental instrument parameters, Aₛ(λ), r(λ), f(λ), can be quantified for each interested wavelength.

Using the experimental instrument parameters, Aₛ(λ), r(λ), f(λ), obtained for individual ISARS wavelengths, a third polynomial in the form of Equation 3 below provides a fitting of the double-beam UV-vis absorbance value, A_{db}(λ), as a variable of the experimental ISARS absorbance, A_{ISARS}(λ), to generate the polynomial fitting coefficients (a₀, a₁, a₂, and a₃). The order of the polynomial fitting can be 2 to 3, depending on the number of the calibration samples and complexity of the correlation between the A_{ISARS}(λ) and A_{db}(λ) of the calibration samples.

$$Eq . 3$$

$${A}_{db}^{ISARS} ( λ ) = {a}_{3} ( λ ) {( {A}_{ISARS} ( λ ) )}^{3} + {a}_{2} ( λ ) {( {A}_{ISARS} ( λ ) )}^{2} + {a}_{1} ( λ ) ( {A}_{ISARS} ( λ ) + {a}_{0} ( λ )$$

Since Aₛ(λ), r(λ), and f(λ) values are available for every ISARS wavelength, a wavelength-specific third-order polynomial is available across the UV-vis wavelength region for wavelength-by-wavelength conversion of the sample's ISARS-based absorbance to its double beam absorbance. As such, once the polynomial fitting coefficients are determined, Equation 3 can be used to determine the sample's double-beam UV-vis absorbance from its ISARS-based absorbance. In some embodiments, where the mechanistic understanding between A_{db}(λ) and A_{ISARS}(λ) may not be necessary, the above-described steps are optional. In this embodiment, the coefficients in Eq. 3 can be obtained by curve-fitting the double-beam absorbance A_{db}(λ) as a function of the experimental ISARS-based absorbance spectrum A_{ISARS}(λ) for the calibration samples.

Upon determining polynomial fitting coefficients, the sample's double beam absorption and scattering extinction spectra can be quantified. In this embodiment, the ISARS-based spectrum for the sample can be obtained using the ISARS spectroscopy system 100 described herein. Using the computer system 500 and processors 502A-502N, the sample's ISARS-based absorbance spectrum can be calculated from the ISARS-based spectrum obtained by the ISARS spectroscopy system 100 using Equation 2 described above. The sample's ISARS-based absorbance spectrum can then be correlated to its double-beam absorption spectrum by using Equation 3 noted above.

In some embodiments, the computer system 500 and processors 502A-502N can determine the sample's ISARS-derived double-beam light scattering spectrum from the ISARS-derived double-beam absorption spectrum. In this embodiment, a conventional spectrophotometer may be used to measure the sample's double-beam UV-vis extinction spectrum E_{db}(λ). Using Equation 4 below, the ISARS-derived double-beam absorbance spectrum

$${A}_{db}^{ISARS} ( λ )$$

can be subtracted from the double-beam UV-vis extinction spectrum E_{db}(λ) to arrive at the ISARS-derived double-beam light scattering extinction spectrum

$${S}_{db}^{ISARS} ( λ ) .$$

$${S}_{db}^{ISARS} ( λ ) = {E}_{db} ( λ ) - {A}_{db}^{ISARS} ( λ ) \qquad Eq . 4$$

The ISARS spectroscopy systems and methods presented herein are applicable to all solution samples for quantitative separation of light absorption and scattering contribution to the sample UV-vis extinction spectra obtained with conventional double-beam spectrophotometers. The ISARS methods and systems can be used to characterize emerging macromolecules, supramolecules, and nanoscale materials that are often simultaneous light absorbers, scatterers, and some cases also emitters. The ISARS methods and systems can also be used in various fields and areas. For example, the systems and methods may be used in sensing, imaging, industry process controls, and therapy (such as photodynamic or photothermal ones) applications. In another application, the disclosed systems and methods may be used in flow cytometry, for example to identify cell types. In yet another application, the disclosed systems and methods may be used to identify cell types in biopsy samples for point-of-care pathology. In other examples, the systems and methods may provide spatially localized measurements of the optical absorption spectrum of complex mediums, for example to image or identify the spatial distribution of molecular characteristics within the medium.

### EXAMPLE

The following non-limiting example demonstrates the ISARS spectroscopy systems and methods in accordance with the present disclosure. The example is merely illustrative of the preferred embodiments of the present disclosure and is not to be construed as limiting the disclosure, the scope of which is defined by the appended claims.

### Example 1: Integrating-Sphere-Assisted Resonance Synchronous Spectroscopy for Quantification of Materials' Double-Beam UV-vis Absorption and Scattering Extinction

### Materials and Methods

Chemicals and Equipment. Cu(NO₃)₂, KMnO₄, NiSO₄, and Rhodamine 6G were obtained from Sigma-Aldrich and used as received. Ultrapure BaSO₄ was obtained from Nacalai teque (Tokyo, Japan, Lot #M9P7734). The COOH-functionalized CdTe core-type quantum dots were purchased from Sigma-Aldrich (Lot #MKBZ9296V). The polystyrene NPs (PSNPs, Cat #21753-15) and fluorescent polystyrene NPs (fPSNPs, Cat #18719) with a diameter of 0.38 μm and 0.01 μm, respectively, were purchased from Polysciences Inc. Nanopure water (18.2 MΩ cm-1, Thermo Scientific) was used in all sample preparations. All spectra were obtained at room temperature in a 1-cm square fused quartz UV-vis or fluorescence cuvette.

UV-vis and ISARS spectral acquisition. UV-vis extinction and the absorbance spectra acquired with IS-equipped UV-vis spectrophotometer were taken with a Shimadzu UV-2600i Spectrophotometer with an ISR-2600 integrating sphere accessory (Duisburg, Germany). ISARS spectra were obtained using a Fluoromax-4 spectrophotometer (Horiba Jobin Yvon, Edison, NJ, USA) equipped with a K-Sphere Petite integrating sphere (Horiba PTI) with an internal diameter of 80 mm. A neutral density filter with an optical density of 2.0±0.05 from 200 nm to 1100 nm (Thor Labs) was also used for all ISARS spectra. Unless specified otherwise, all ISARS spectra were acquired with an integration time of 0.3 s and a bandwidth of 2 nm for both excitation and detection monochromators. The spectral intensity was the ratio between the signal from the sample detector and reference detector (S1/R1).

Operation procedure for the ISARS spectroscopic measurements. The general procedures for the ISARS technique are divided into two parts. The first is the characterization of the instrument parameters including Aₛ(λ), r(λ), f(λ) values and subsequently the polynomial fitting coefficients defined herein. The second part is for application of the characterized setup for quantification of the sample absorption and scattering extinction.

### Part 1: Characterization of Instrument Parameters and the Polynomial Fitting Coefficients.

1. Acquire ISARS spectrum of the solvent

$${I}_{Solvent}^{ISARS , obsd} ( λ )$$

using the procedures described herein.

2. Acquire the double-beam UV-vis spectra A_{db}(λ) and the ISARS spectra of the Aₛ(λ), r(λ), f(λ) calibration samples

$${I}_{Sample}^{ISARS , obsd} ( λ ) .$$

These samples should be molecular chromophores whose double beam UV-vis extinction spectrum can be approximated as absorbance spectrum.

3. Acquire the baseline spectrum using saturated solutions of the chromophores identified herein.

4. Use the solvent and the sample ISARS spectrum obtained in steps 1 and 2, and the baseline spectrum in step 3 to calculate using Eq. 2 the ISARS-based absorbance spectra for the A_{ISARS}(λ) spectra for the Aₛ(λ), r(λ), f(λ) calibration samples.

5. Curve-fit the experimental correlation between the double-beam UV-vis absorbance and the ISARS absorbance using Eq. 1 to determine the Aₛ(λ), r(λ), f(λ) values for each interested wavelength.

6. Use the experimental Aₛ(λ), r(λ), f(λ) values determined in step 5 and Eq. 1 to produce a series of pair A_{ISARS}(λ) and A_{db}(λ) values, and then use the third polynominal fitting of the A_{db}(λ) value as a variable of A_{ISARS}(λ) to generate the polynomial fitting coefficients (a₀, a₁, a₂, and a₃) in Eq. 3.

### Part 2: Use the Characterized Instrument Settings for Quantification of the Sample Absorption and Scattering Extinction.

7. Measure the sample double-beam UV-vis extinction spectrum E_{db}(λ) using the conventional UV-vis spectrophotometer.

8. Acquire the sample ISARS spectrum using the procedures described herein.

9. Use the solvent and the sample ISARS spectrum obtained in steps 1 and 8, and the baseline spectrum in step 3 to calculate using Eq. 2 the sample ISARS-based absorbance spectrum A_{ISARs}(λ).

10. Derive the sample double-beam absorbance spectrum

$${A}_{db}^{ISARS} ( λ )$$

from the sample ISARS-based absorbance spectrum A_{ISARS}(λ) using Eq. 3. The polynomial fitting coefficients (a₀, a₁, a₂, and a₃) needed for this conversion are obtained in step 6.

11. Subtract the ISARS-derived double-beam absorbance spectrum

$${A}_{db}^{ISARS} ( λ )$$

from the double-beam UV-vis extinction spectrum E_{db}(λ) for the ISARS-derived double-beam light scattering extinction spectrum

$${S}_{db}^{ISARS} ( λ ) .$$

### Results and Discussion

Baseline Quantification. ISARS baseline spectrum

$${I}_{B}^{ISARS} ( λ )$$

can be determined with strongly light-absorbing samples. An ideal baseline evaluation sample should have intense absorption in the entire wavelength range (300 nm to 800 nm). However, it is difficult for one sample to have sufficient absorptivity over such a broad wavelength region. Among a series of molecular chromophores explored, KMnO₄, Cu(NO₃)₂, and NiSO₄ allowed for determination and cross-validation of the baseline across the entire wavelength region.

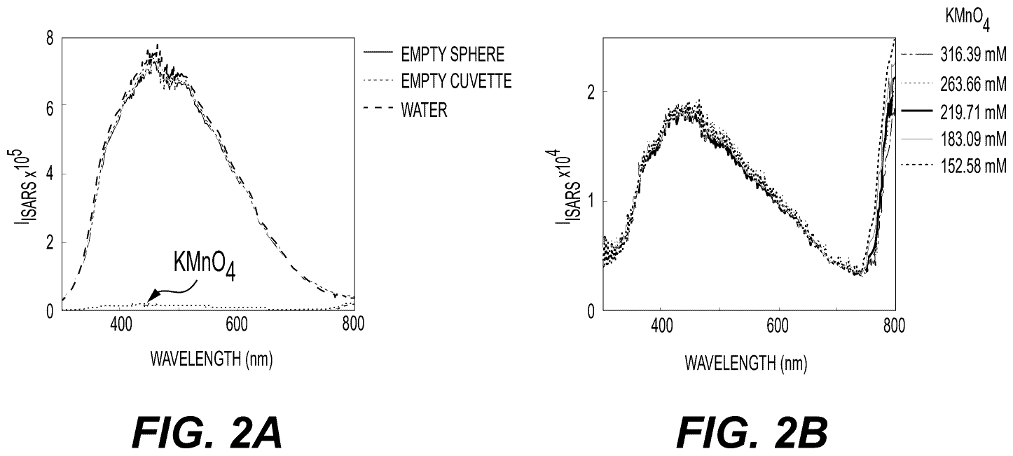

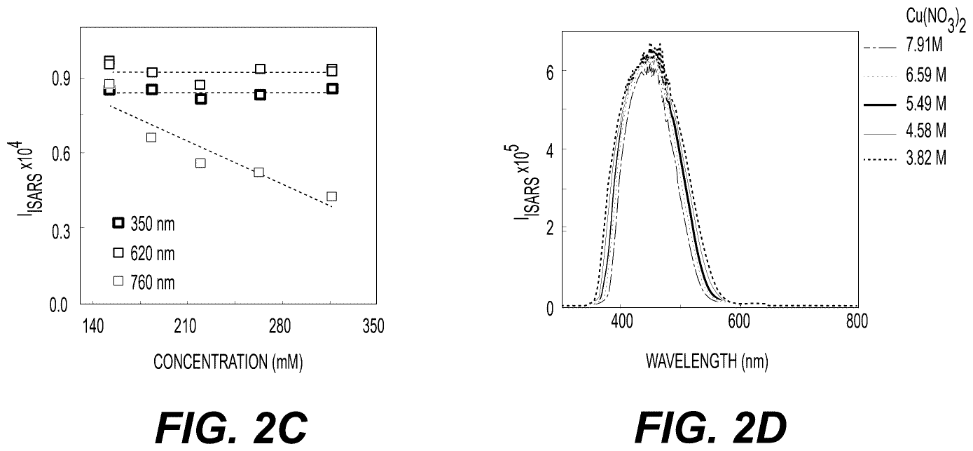

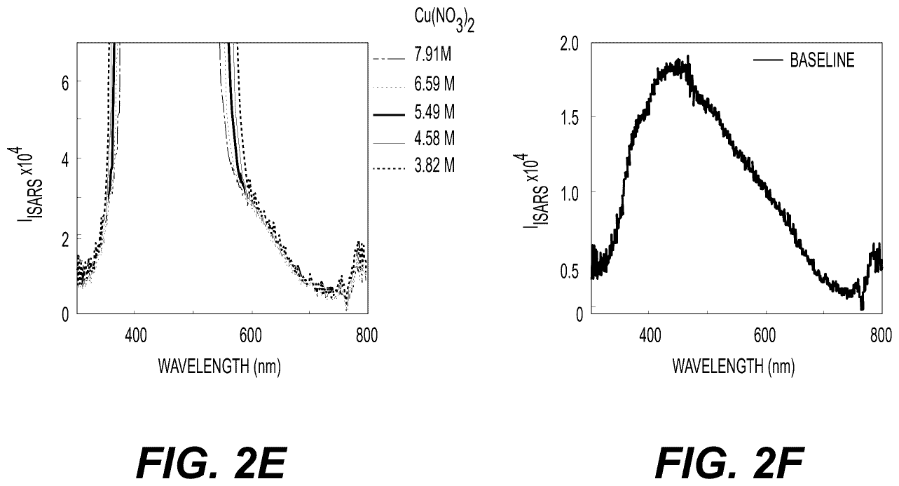

An empty integrating sphere (IS), an IS with the empty cuvette, and the IS with a water-containing cuvette all gave very similar ISARS spectra, as shown in FIG. 2A, indicating that the quartz cuvette has negligible light absorption, and the specular reflection by the cuvette has no significant impact on the ISARS intensity. Otherwise, the ISARS spectrum obtained using the IS with and without the cuvette should be significant.

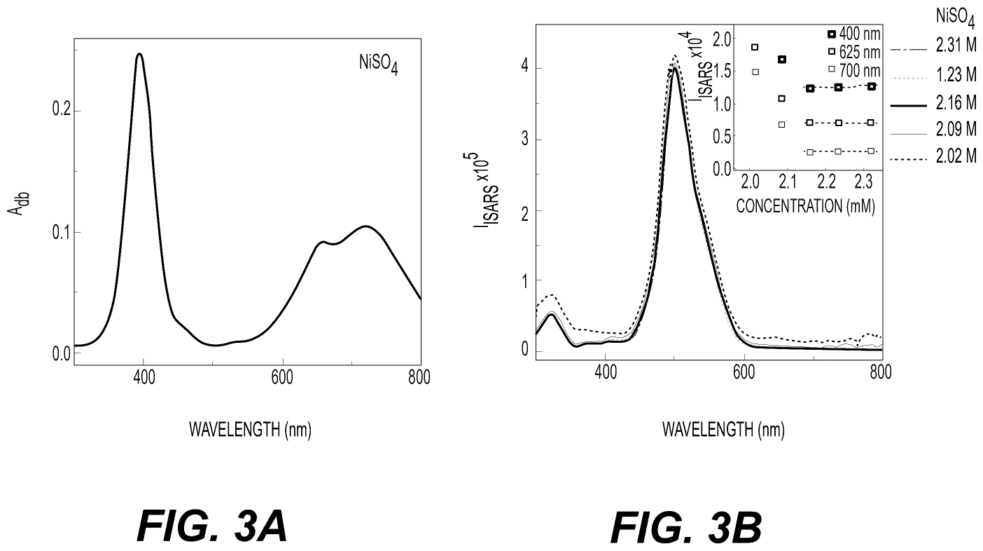

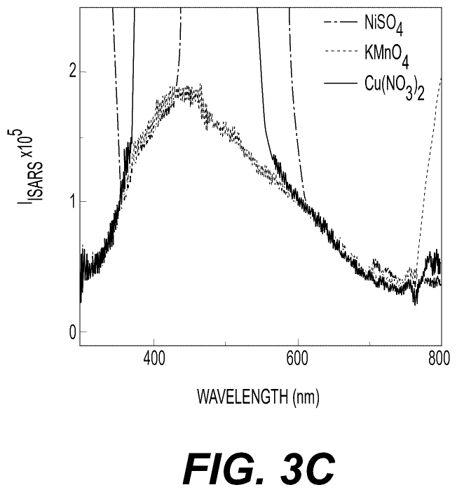

The ISARS-baseline spectrum was determined using saturated and near-saturated KMnO₄, Cu(NO₃)₂, and NiSO₄ solutions. Experimental identification of the workable wavelength region of these chromophores was performed using a sample dilution method. Only the ISARS signal that is independent of the chromophore concentration is taken as the baseline intensity at the probe wavelength. As illustrated in FIGS. 2A-2C, KMnO₄ alone enables baseline quantification from 300 nm to 750 nm. As shown in FIGS. 2D-2F, Cu(NO₃)₂ allows the baseline quantification from 300 nm to 370 nm and that from 750 nm and 800 nm. The workable wavelength region of NiSO₄ is from 330 nm to 450 nm and from 600 nm to 800 nm, as shown in FIG. 3A. The high similarity in the baseline ISARS spectra obtained with KMnO₄, Cu(NO₃)₂, and NiSO₄ in their commonly workable wavelength regions provided a cross-validation of this baseline quantification method (FIGS. 3B-3C).

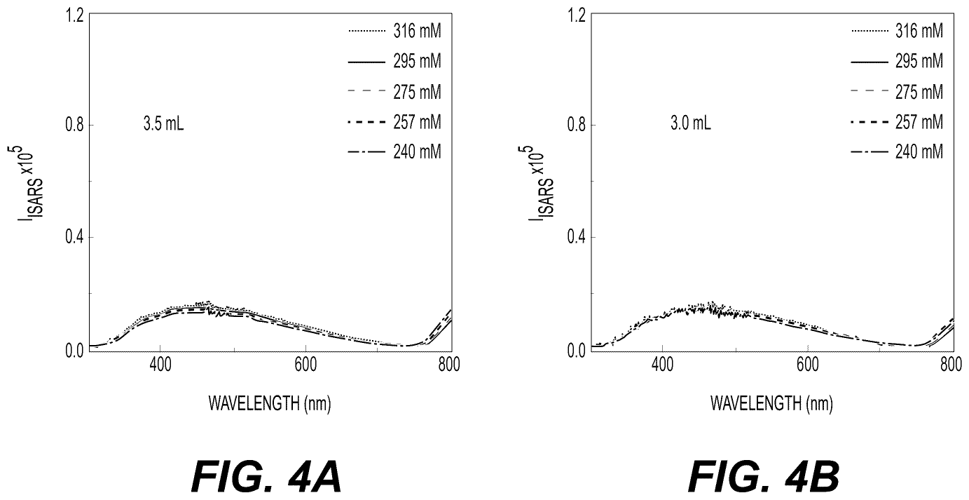

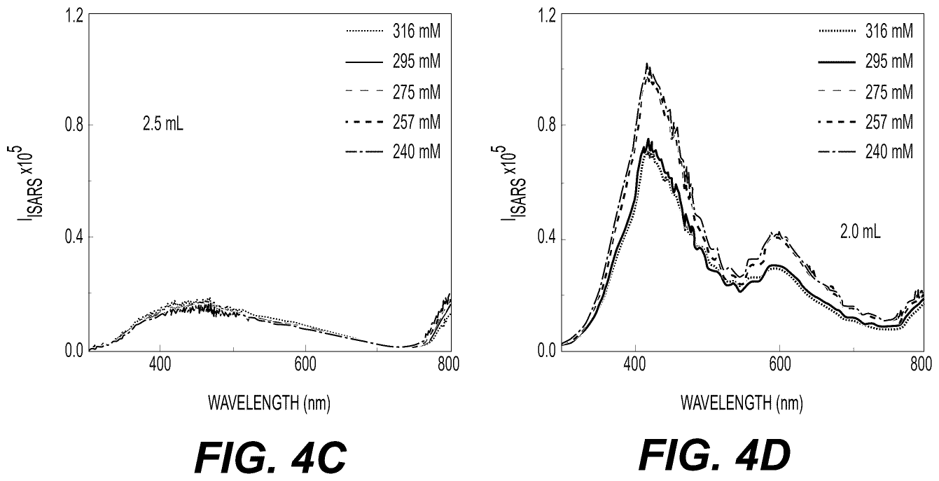

Sample volume is critical for reliable baseline spectrum determination. As shown in FIGS. 4A-D, the ISARS intensities of the three most concentrated KMnO₄ samples are approximately the same in the spectra obtained with a sample volume of 3.5 mL, 3.0 mL, and 2.5 mL. That is, a constant baseline spectrum (within the measurement errors) is acquired when the sample volume is 2.5 mL or above. However, the ISARS intensity monotonically increases when the volume of KMnO₄ solution in the cuvette is reduced to 2 mL. This observation is not surprising because r(λ) decreases with the reduced volume in the cuvette. To ensure the reliability of the baseline correction, the sample volume of 3 mL was used in all the subsequent measurements.

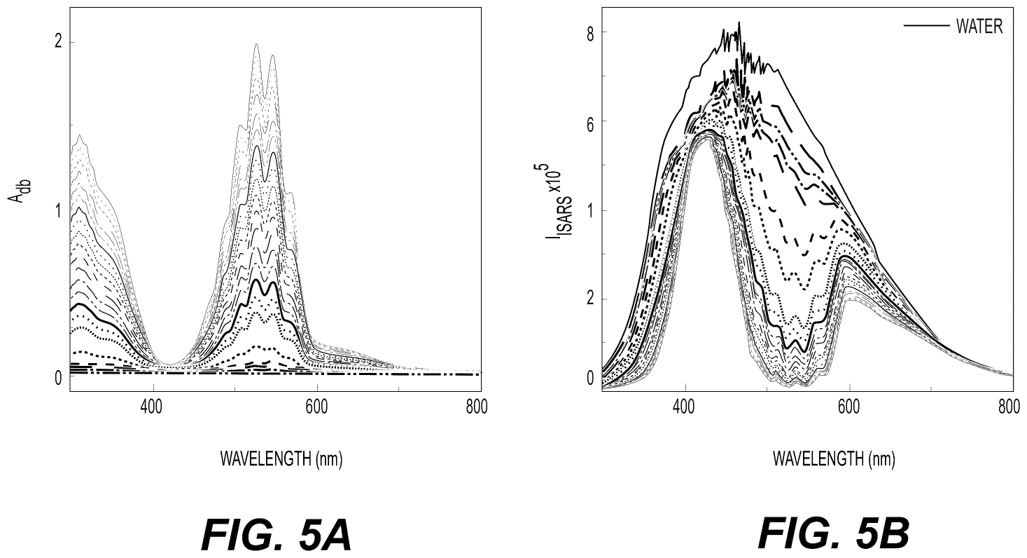

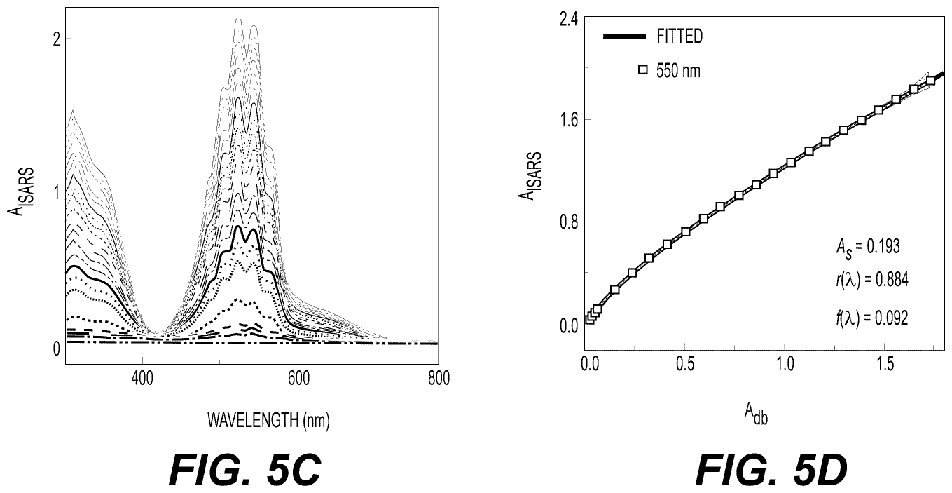

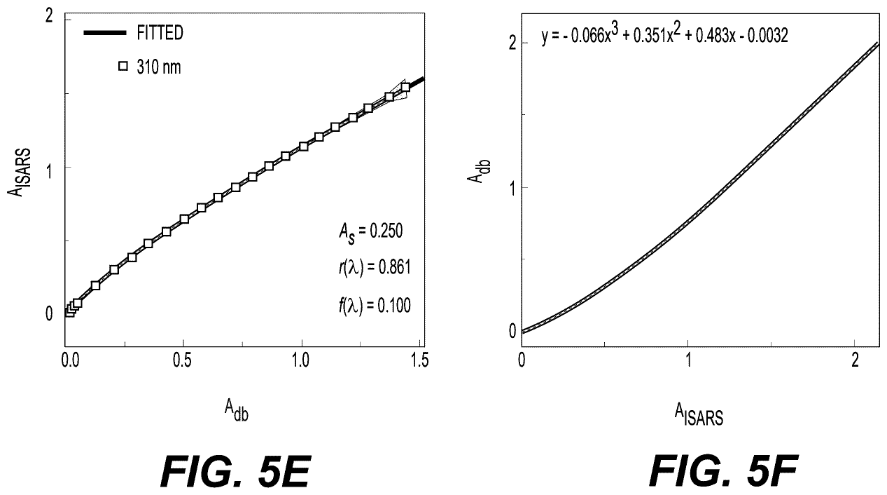

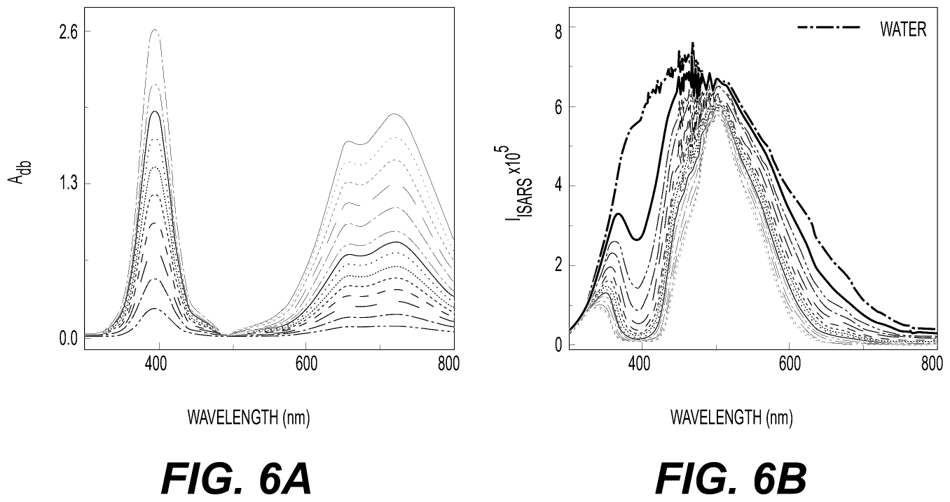

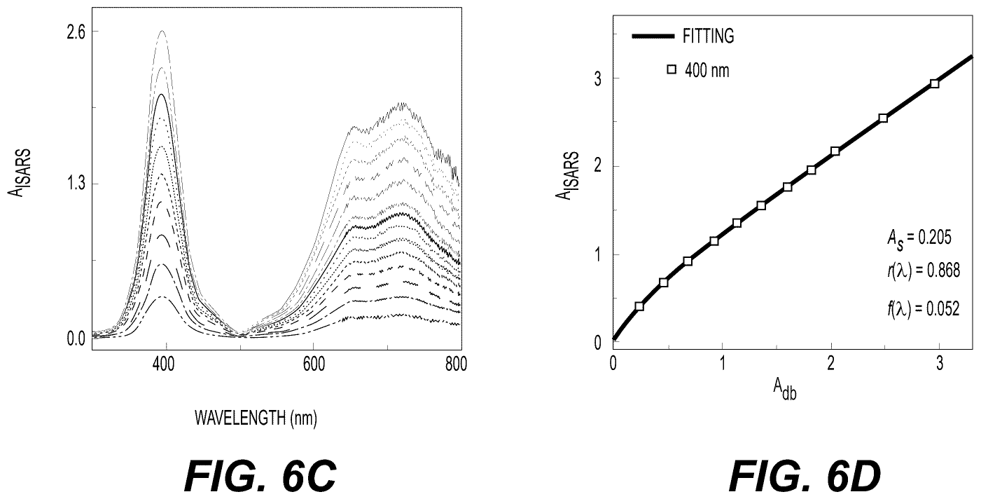

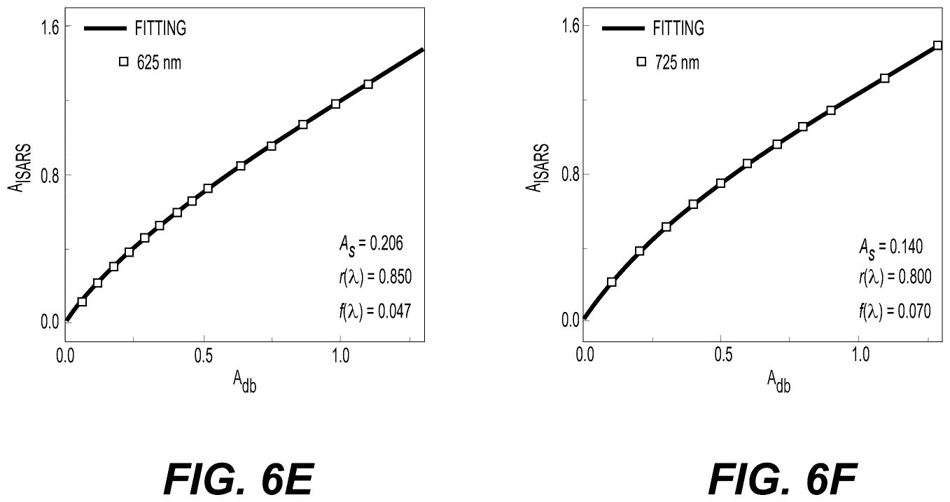

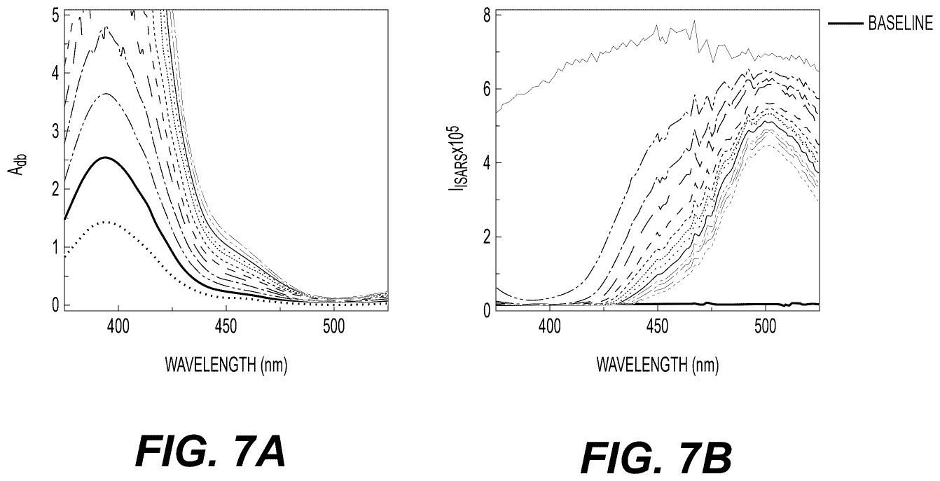

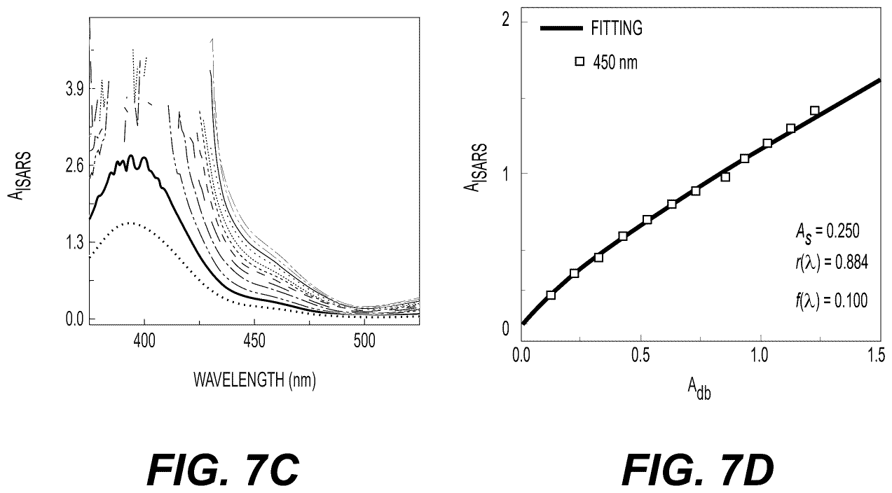

Correlation between A_{db}(λ) and A_{ISARS}(λ). The validity of the analytical model (Eq. 1) for correlating the sample A_{db} (λ) and A_{ISARS}(λ) was evaluated using KMnO₄ and NiSO₄ as the two chromophores absorbing collectively across the entire wavelength from 300 nm to 800 mm. The data obtained with KMnO₄ are shown in FIGS. 5A-5F and that for NiSO₄ are shown in FIGS. 6A-6F and 7A-7D. The A_{ISARS}(λ) values (FIG. 5C) are calculated using Eq. 2 using the baseline corrected ISARS spectra (FIG. 5B) obtained with the solvent and the KMnO₄ solutions. The A_{db}(λ) are A_{ISARS}(λ) nonlinearly correlated with each other, which is consistent with the theoretical model derived herein (Eq. 1). Fitting the experimental A_{ISARS}(λ) values as the function of A_{db}(λ) data obtained with KMnO₄ and NiSO₄ with this three-parameter model (Eq. 1) determines the IS absorbance As(λ), the effective photon pathlength through the cuvette inside the IS after each diffuse reflection r(λ), and the port fraction f(λ) as a function of the excitation wavelength across the entire UV-vis region (FIG. 8). The samples used for curve-fitting determination of the Aₛ(λ), r(λ), and f(λ) values all have a double-beam absorbance 0.05 or above at the evaluated wavelength. The fitting errors with the determined As(λ), r(λ), and f(λ) values are all negligibly small (FIGS. 5D and 5E, and FIGS. 6A-6F and 7A-7D). Importantly, the As(λ), r(λ), and f(λ) obtained by curve-fitting the KMnO₄ and NiSO₄ in their overlapping wavelength region are all in good agreement, indicating that As(λ), r(λ), and f(λ) values are sample-independent parameters.

The r(λ) values are 0.85±0.03 cm across the wavelength region, which is smaller than the physical pathlength of the 1-cm square cuvette. This result is not surprising because after each diffuse reflection, only a small fraction of photons can go through the samples inside the IS, and the stepwise pathlength is an average of the photons both passing and bypassing the sample after each diffuse reflection. The f(λ) values in the 300 nm to 660 nm region are 0.05±0.03. Such port fraction is significantly higher than 0.008, the port area fraction of the IS used herein. This discrepancy strongly suggests that the probability of photons exiting from the excitation and detection port depends not only on the physical port fraction, but also on the internal IS configuration and the light scattering depolarization by the IS. The commercial IS used herein has three baffles. These baffles likely enhanced the photon escape from the excitation and/or detection ports.

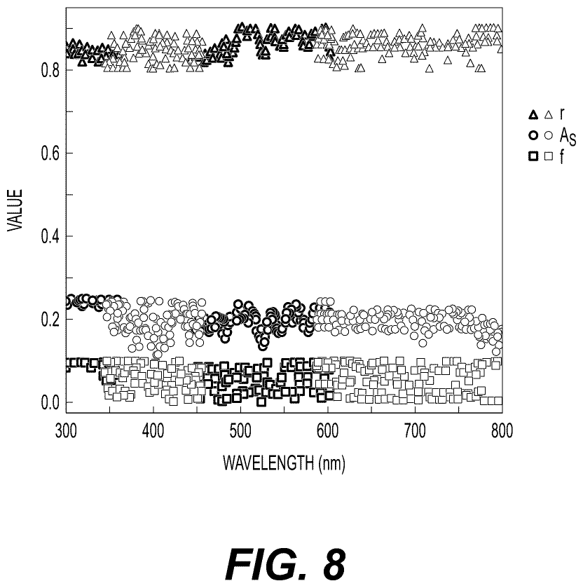

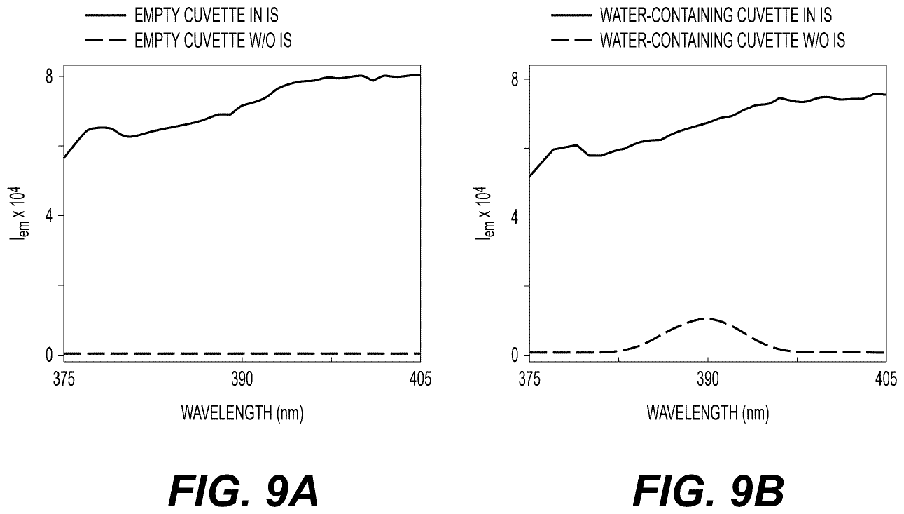

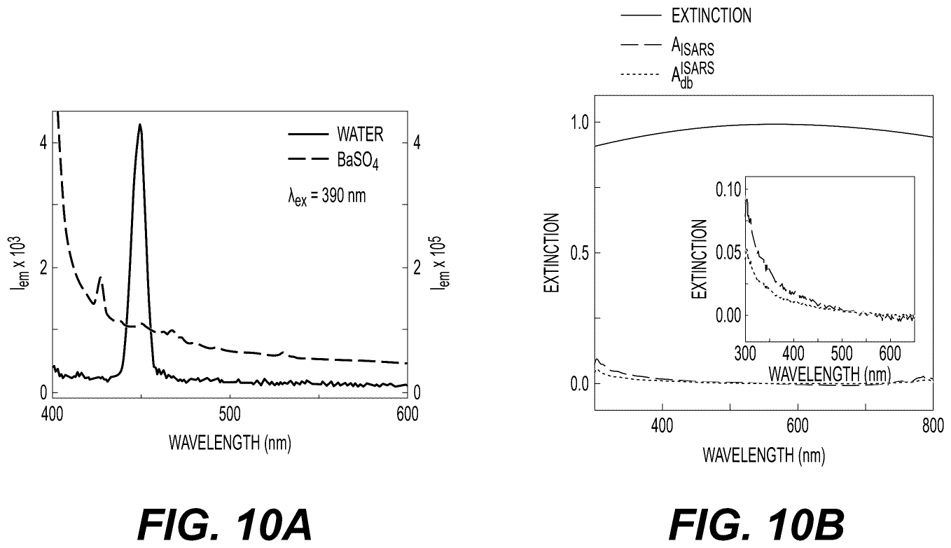

The average Aₛ(λ) value is 0.2±0.08 in the wavelength region from 300 nm to 800 nm, which is significantly higher than the reflectance (>96% to 99%) specified by the IS vendor. The absorbance is especially large in the wavelength region below 350 nm. One likely reason is that chemical contamination in the inner IS coating layer that can occur during the IS fabrication and IS usages. This hypothesis is supported by the fact that exceedingly strong background IS fluorescence in the background fluorescence spectrum was obtained with the empty cuvette and cuvette with water, both with and without the IS (FIGS. 9A-9B), and the fluorescence spectrum obtained with ultrapure barium sulfate powder (FIGS. 10A-10B). The latter is one of the most used IS coating materials for its high reflectivity. Without the IS fluorescence impurities (thereby absorption impurity, because light absorption must proceed photoluminescence), one would expect fluorescence spectra obtained with the empty cuvette and water-containing cuvette inside the IS to be approximately the same as their respective counterparts acquired without IS. Such a strong IS background fluorescence interference is surprising because the IS employed herein had been used for less than one year and it exhibited no visual contamination.

The strong Raman and fluorescence background interference from the IS itself also highlights the difficulty in using UV-vis spectrophotometer as a detector for the IS-based quantification. The spectra obtained with double UV-vis spectrophotometers equipped with IS accessory can be viewed as an ISARS with an infinitely large detection wavelength bandwidth. In this case, any IS background fluorescence and Raman scattering will affect IS-based absorbance quantification. In contrast, with the ISARS spectrophotometer developed herein, one can minimize IS fluorescence and Raman interference by controlling the detection monochromator bandwidth, while the IS absorption interference is included in the mathematic model (Eq. 1).

Prediction

$${A}_{db}^{ISARS} ( λ )$$

using experiment A_{ISARS}(λ). Besides providing mechanistic quantitative understanding of the correlation between the ISARS-based absorbance and double-beam absorbance, the analytical model (Eq. 1) also provides a basis for converting the sample instrument-dependent ISARS-based absorbance to its instrument-independent double-beam absorbance. Equation 1 can be used to calculate the sample ISARS-based UV-vis absorbance A_{ISARS}(λ) from its double-beam UV-vis absorbance A_{db}(λ). However, there is no analytical solution for the reverse process, determination of the sample double-beam A_{db}(λ) from its experimental A_{ISARS}(λ). This problem can be solved through polynomial fitting of the numerical correlation between A_{ISARS}(λ) and A_{db}(λ) derived with the analytical model (Eq. 1) using the experimental Aₛ(λ), r(λ), and f(λ) values evaluated for each ISARS wavelength. A third polynomial with a general form of Eq. 3 gives an excellent fitting using the experimental AS(λ), r(λ), and f(λ) values obtained for individual ISARS wavelengths. An example of such third polynomial fitting is shown in FIG. 5F using the data generated with Eq. 1 using the Aₛ(λ), r(λ), and f(λ) values obtained in FIG. 5D. Since Aₛ(λ), r(λ), and f(λ) values are available for every ISARS wavelength (FIGS. 9A-9B), a wavelength-specific third-order polynomial is available across the UV-vis wavelength region for wavelength-by-wavelength conversion of the sample ISARS-based absorbance to its double beam absorbance. For discussion simplicity,

$${A}_{db}^{ISARS} ( λ )$$

is referred to as the double-beam UV-vis absorbance deduced from the experimental

$${A}_{ISARS} ( λ )$$

spectrum, and to differentiate deduced double-beam absorbance

$${A}_{db}^{ISARS} ( λ )$$

from A_{db}(λ), the UV-vis absorbance directly measured with double-beam spectrophotometer.

$${A}_{db}^{ISARS} ( λ ) = {a}_{3} ( λ ) {( {A}_{ISARS} ( λ ) )}^{3} + {a}_{2} ( λ ) {( {A}_{ISARS} ( λ ) )}^{2} + {a}_{1} ( λ ) {A}_{ISARS} ( λ ) + {a}_{0} ( λ ) \qquad Eq . 3$$

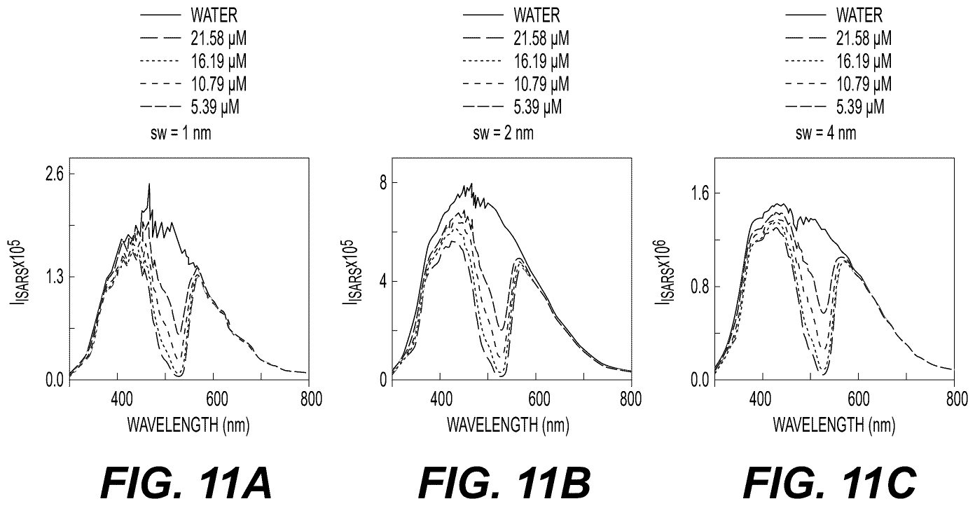

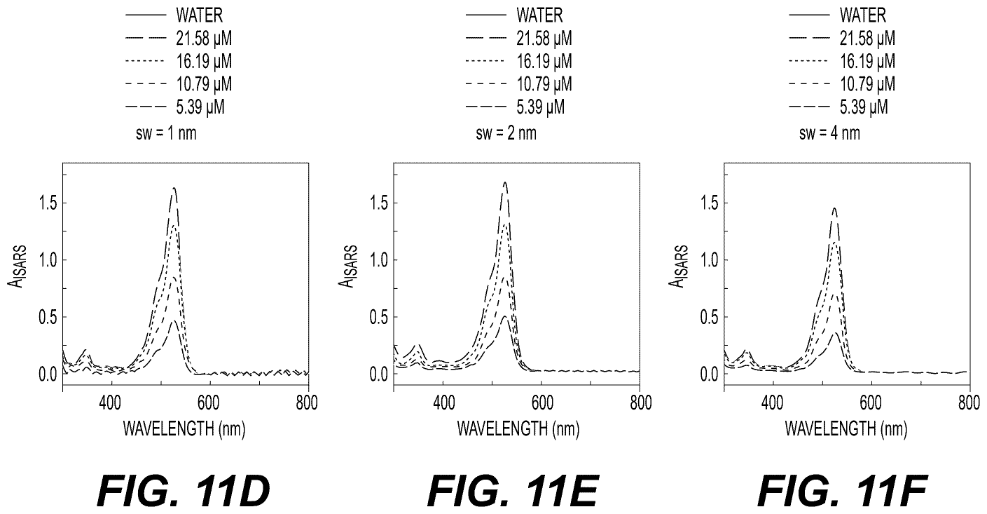

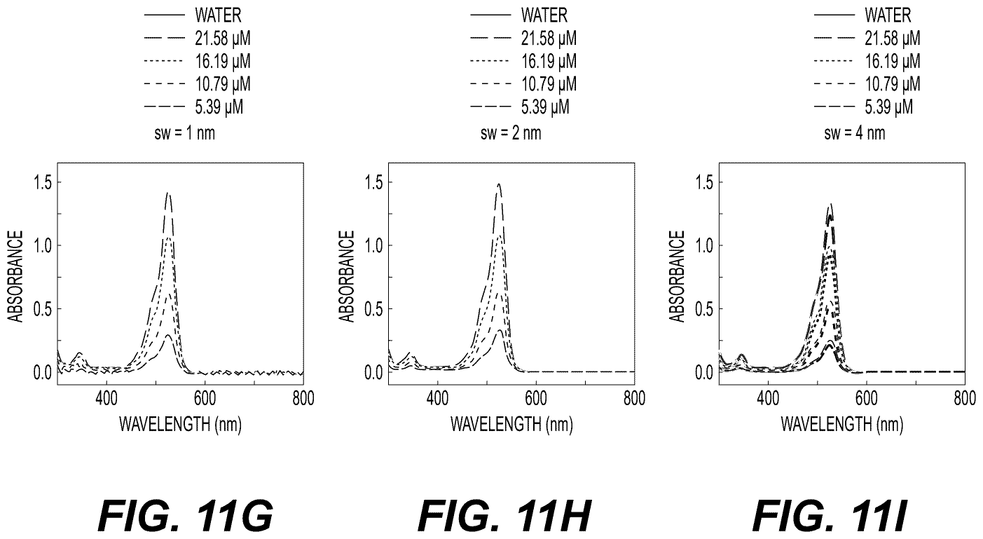

The effectiveness of Eq. 3 for predicting sample double-beam UV-vis absorbance from its ISARS-based absorbance was investigated with R6G (FIGS. 11A-11I). Since R6G has not been used for quantification of Aₛ(λ), r(λ), and f(λ) values at any ISARS wavelengths, it allows critical validation of third order polynomial equations derived from these values. Further, as an ORF-active molecular fluorophore, R6G is approximately a pure absorber in the wavelength region below 515 nm under the resonance excitation and detection conditions, but it is a simultaneous light absorber and emitter in its ORF-active region from 515 nm to 560 nm region. As such, R6G allows for exploration of not only the effectiveness of conversion of sample ISARS-based absorbance to its double-beam absorbance, but also the possible ORF interference on the ISARS-based absorbance quantification. The reason R6G is used with a relatively broad absorbance range (approximately 0.25 to approximately 1.5) is to probe the possible concentration dependence of this ISARS-based double-beam absorbance quantification method.

The R6G ISARS intensity monotonically increased with increasing monochromator bandwidth, as shown in FIGS. 11A-11C, which is due to the amount of the incident and detected photons that both increased with increasing slit widths. However, the A_{ISARS}(λ) (FIG. 11D-11E) and

$${A}_{db}^{ISARS} ( λ )$$

FIG. 11G-11H) obtained with the 1 nm slit width were essentially identical with their respective counterpart acquired with 2 nm slit widths. Furthermore, the

$${A}_{db}^{ISARS} ( λ )$$

and A_{db}(λ) obtained with the 1 nm and 2 nm slit widths were all in excellent agreement across the entire wavelength region, regardless of the R6G ORF-activity at the specific wavelength and the R6G concentrations. These observations offered a critical validation of the ISARS method for predicting the sample double-beam absorbance. They also demonstrated the robustness of the ISARS technique against the fluorescence interference on the A_{ISARS}(λ) or

$${A}_{db}^{ISARS} ( λ )$$

evaluation. Otherwise, the R6G

$${A}_{db}^{ISARS} ( λ )$$

intensity would be lower than A_{db}(λ) in its ORF-active wavelength region from 515 nm to 565 nm.

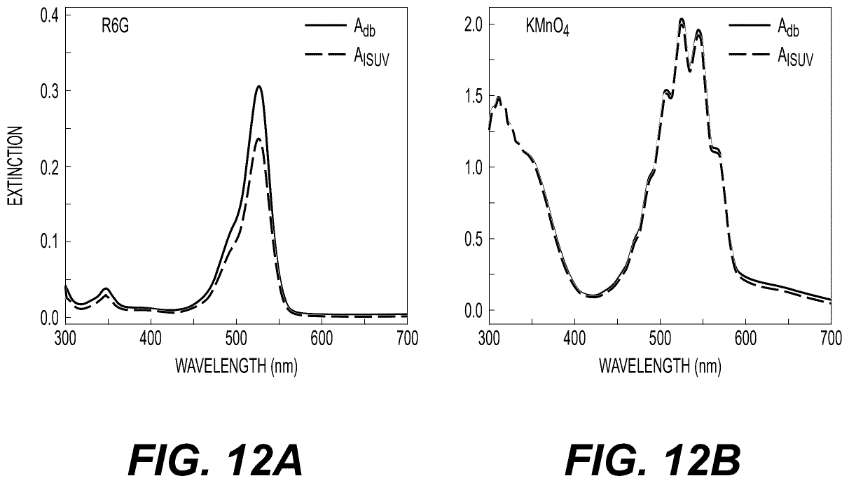

The R6G absorbance quantified with the commercial IS-equipped spectrophotometer (Shimazu UV-2600i, integrating sphere accessory ISR-2600) was significantly lower than that obtained with the same spectrophotometer but with no IS, while the KMnO₄ absorbance spectrum acquired with the IS-equipped UV-vis spectrophotometer was essentially the same as that obtained without the IS (FIGS. 12A-12B). These data confirm that the IS-based absorbance quantification with the UV-vis spectrophotometer as a detector is susceptible to fluorescence interference. Collectively, the R6G data shown in FIGS. 11A-11I and FIGS. 12A-12B provide conclusive evidence that ISARS is drastically more reliable than the IS-equipped spectrophotometers for quantifying light absorbance of fluorescent samples.

The peak intensities of A_{db}(λ) A_{ISARS}(λ),

$${A}_{db}^{ISARS} ( λ )$$

spectra obtained with monochromator bandwidth of 4 nm was significantly smaller that their respective counterparts obtained with 1 nm and 2 nm, which is due to the polychromatic effect in the absorbance measurements. The UV-vis absorbance is reduced when the monochromator bandwidth for the spectral acquisition is broader than the intrinsic peak wavelengths where the spectral intensity are approximately constant. One possible reason the

$${A}_{db}^{ISARS} ( λ )$$

intensity obtained with the 4 nm monochromator bandwidth was lower than that of the A_{db}(λ) (FIG. 11I) that is also acquired with 4 nm bandwidth is the mismatch between the monochromator used for the spectrophotometer-based double-beam absorbance A_{db}(λ) measurements and ISARS-derived double-beam absorbance

$${A}_{db}^{ISARS} ( λ ) .$$

Mechanistically the absence of significant ORF interference on the ISARS-based absorbance quantification in the sample ORF-active wavelength region was due to the relatively low sample ORF quantum yield, which is usually below 0.03 for common molecular fluorophores, and the fact that ORF photons inside the IS can be reabsorbed by the sample or the IS itself. The reabsorbed ORF photons will either be converted to heat or reemit as secondary fluorescence photons. However, the probability of the remitted fluorescence remaining in the narrow (1 to 4 nm) resonance excitation and emission wavelength regions should be very small.

While the small monochromator bandwidth is more robust against ORF interferences, large monochromator bandwidth offers higher spectral signal-to-noise ratio. Since the 2 nm monochromator bandwidth offers higher spectral signal-to-noise ratio without introducing spectral distortion, all subsequent ISARS-based spectral acquisition was performed with this monochromator bandwidth.

Nanoparticle absorption and scattering extinction. The utility of the ISARS technique for experiment quantification of the absorption and scattering extinction contribution to the sample UV-vis extinction measured with double-beam spectrophotometer was demonstrated with three representative nanomaterials PSNP, fPSNP, and QD. PSNPs have been assumed to be pure light scatters in the wavelength region from 300 nm to 800 nm. The optical properties of QDs and fPSNP are much more complicated. Under resonance excitation and detection condition, QDs and fPSNP are simultaneous light absorbers, scatterers, and emitters in the wavelength region where the sample fluorescence excitation and emission spectra overlap, but are simultaneous light scatterer and absorber, or pure scatterer in the other wavelength region. Regardless of their differences, none of the UV-vis spectra obtained with these samples with the double-beam spectrophotometer can be interpreted as the sample absorbance spectrum.

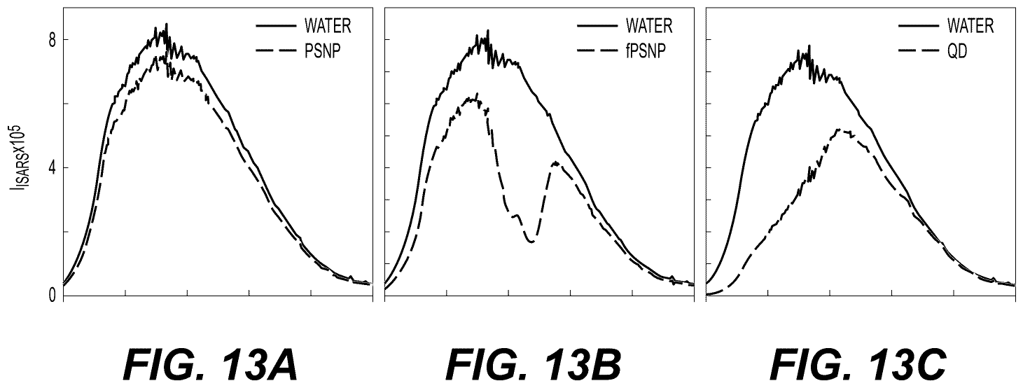

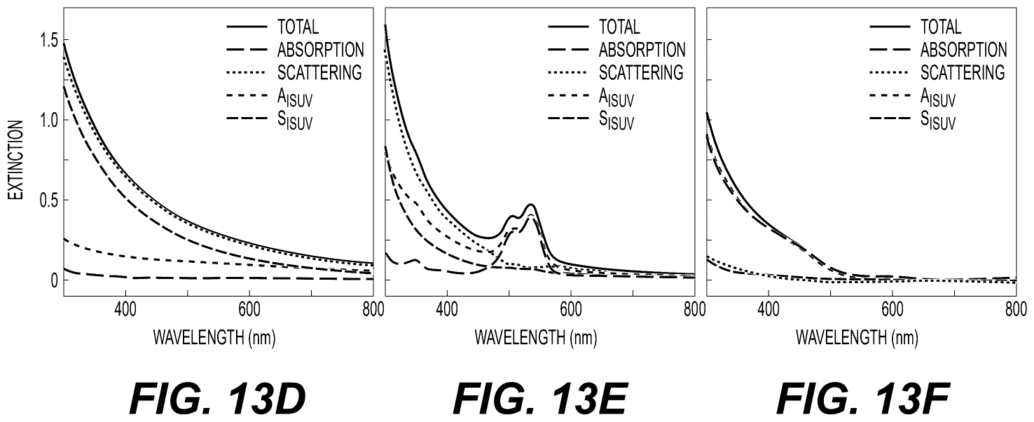

The first step for ISARS quantification of the sample absorption and scattering contribution to its double-beam extinction spectrum was to deduce the sample double-beam absorbance spectrum through the ISARS measurement, as shown in FIGS. 13A-13F. The scattering extinction spectrum was then obtained by subtracting the double-beam absorbance from the sample double-beam UV-vis extinction spectrum (Eq. 4). Conversely, light scattering extinction based on measurements performed with the IS-equipped UV-vis spectrophotometer was obtained by subtracting A_{ISEUV} (A) spectra from the double-beam UV-vis extinction spectrum (Eq. 5).

$${S}_{db}^{ISARS} ( λ ) = {E}_{db} ( λ ) - {A}_{db}^{ISARS} ( λ ) \qquad Eq . 4$$

$${S}_{ISEUV} ( λ ) = {E}_{db} ( λ ) - {A}_{ISEUV} ( λ ) \qquad Eq . 5$$

The ISARS data showed that relative absorption and scattering contribution to the nanomaterials' UV-vis extinction spectra varied significantly from one type of nanoparticle to another. PSNP of 380 nm in diameter (FIGS. 13A and 13D) was predominantly light scattered across the entire wavelength region from 300 nm to 800 nm. The highest absorbance contribution to the PSNP UV-extinction was less than 5%, which is observed at 300 nm. In contrast, QD is predominantly a light absorber in the wavelength region with detectable UV-vis features (<620 nm), while the relative light scattering and absorption contribution to the fPSNP extinction spectrum was strongly wavelength dependent. The double-beam absorbance spectrum

$${A}_{db}^{ISARS} ( λ )$$

determined from the fPSNP ISARS measurement qualitatively resembles a UV-vis spectrum of organic dye. The data obtained with the three representative nanoparticles that differ significantly in their relative scattering and absorption activities shows the effectiveness of the ISARS methodology for experimental separation of the sample UV-vis extinction spectra measured with double-beam spectrophotometer into its absorption and scattering extinction spectra.

While the R6G data (FIGS. 12A-12B) showed the susceptibility of the IS-equipped spectrophotometer to fluorescence interference in fluorescence quantification, the data obtained with the PSNP and fPSNP (FIGS. 13A-13F) demonstrated the susceptibility of this technique to the light scattering interferences. Polystyrene is a known light scatterer and has commonly been used for light scattering based sizing, and the ISARS method showed that there was no significant PSNP light absorption across the entire wavelength region. However, the IS-equipped spectrophotometer gave falsely high UV-vis absorbance in the entire wavelength. The reason that the broad band absorbance in the A_{ISUV} spectrum of fPSNP is higher than that of PSNP is due most likely to the different sizes. fPSNPs are about 10 nm in diameter that can be approximated as Rayleigh scatterers with the probed wavelength ranges. In this case, while the scattered photons propagated globally from every direction, only the scattered photons propagated forwardly can be captured by the IS. The large amount of the scattered photons that escape the IS capture leads to significantly overestimated sample absorbance. In contrast, PSNPs are about 380 nm in diameter that are likely Mie scatterers. Most of the scattered light are propagated forward and background. In this case, the fraction of the scattered photons escaping from the IS capture is relatively small, which explains why the degree of the absorbance overestimation for the PSNP is small in comparison to the fPSNP.

Conclusion. The ISARS spectroscopic method developed herein demonstrates use for quantification of the double-beam UV-vis absorbance spectra for samples with different optical complexities, from approximately pure light absorbers, pure scatterers, to simultaneous absorbers, scatterers, and emitters. A nonlinear three-parameter analytical model was developed for correlating the sample ISARS-based and double-beam UV-vis absorbance. The optimal excitation and detection wavelength bandwidth for the ISARS acquisition is 2 nm, as it offers high spectral signal-to-noise ratio without causing detectable spectral distortion. This ISARS-based UV-vis absorbance quantification method is applicable to all solution samples for quantitative separation of light absorption and scattering contribution to the sample UV-vis extinction spectra obtained with conventional double-beam spectrophotometers. The ISARS method can be used to characterize emerging macromolecules, supramolecules, and nanoscale materials that are often simultaneous light absorbers, scatterers, and also emitters.

The methods and apparatuses described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the apparatuses and methods in addition to those shown and described herein will become apparent to those skilled in the art from the foregoing description. Such modifications are also intended to fall within the scope of the disclosure. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. An integrating-sphere-assisted resonance synchronous (ISARS) spectrophotometer, comprising:
a light source,
an excitation monochromator configured to separate light from the light source and output a selected excitation wavelength (λₓ) of the excitation light,
an integrating sphere having an inner surface configured to diffuse reflect light reaching the surface,
a detection monochromator configured to receive light exiting the integrating sphere and output a selected detection wavelength (λ_{d}) of the exit light, wherein the excitation wavelength (λₓ) and the detection wavelength (λ_{d}) are substantially the same and varied simultaneously over a wavelength region, and
a detector configured to detect the light from the detection monochromator.

2. The ISARS spectrophotometer of claim 1, wherein the integrating sphere comprises a sample positioned therein.

3. The ISARS spectrophotometer of claim 2, wherein the detector is configured to acquire an ISARS intensity spectrum of the sample.

4. The ISARS spectrophotometer of claim 1, wherein the integrating sphere has an inner diameter ranging from about 4 cm to about 50 cm.

5. The ISARS spectrophotometer of claim 1, further comprising an excitation neutral density filter, a detection neutral density filter, or a combination of both for adjusting the excitation or detection light intensity.

6. An ISARS spectroscopy system for measuring a double-beam absorption spectrum of a sample, comprising:
an ISARS spectrophotometer comprising:
a light source,
an excitation monochromator configured to separate light from the light source and output a selected excitation wavelength (λₓ) of the excitation light,
an integrating sphere having an inner surface configured to diffuse scatter the light, wherein the integrating sphere comprises the sample positioned therein,
a detection monochromator configured to receive light exiting the integrating sphere and output a selected detection wavelength (λ_{d}) of the exit light, wherein the excitation wavelength (λₓ) and the detection wavelength (λ_{d}) are substantially the same and varied simultaneously over a wavelength region,
a detector configured to detect the exit light and acquire an ISARS intensity of the sample, and
a processor operatively connected to the ISARS spectrophotometer, wherein the processor comprises a non-transitory computer readable medium with instructions executable to:
calculate an ISARS-based absorbance spectrum from the ISARS intensity of the sample and convert the ISARS-based absorbance spectrum into the double-beam absorption spectrum.

7. The ISARS spectroscopy system of claim 6, wherein the sample is a fluorescent solution comprising a nanoscale material or macromolecule.

8. The ISARS spectroscopy system of claim 6, wherein the sample is a nonfluorescent solution comprising a nanoscale material or macromolecule.

9. The ISARS spectroscopy system of claim 6, wherein the sample is a solid powder or a film having a thickness from about 100 nm to 2 cm.

10. The ISARS spectroscopy system of claim 6, wherein the detection monochromator is configured to receive the exit light from an exit port of the integrating sphere, wherein the exit port is placed at an angle from about 10 degrees to about 170 degrees with respect to a direction of incidence of the excitation light.

11. The ISARS spectroscopy system of claim 6, wherein the sample is positioned in the integrating sphere at an angle of about 5 degrees to about 85 degrees relative to the incident beam.

12. The ISARS spectroscopy system of claim 6, wherein the integrating sphere further comprises one to three baffles positioned therein.

13. A method for determining a baseline of the ISARS spectrophotometer of claim 1, comprising:
acquiring, with the ISARS spectrophotometer, an ISARS baseline spectra of a baseline sample, wherein the baseline sample is a saturated light absorbing sample.

14. The method of claim 13, wherein the baseline sample comprises potassium permanganate (KMnO₄), copper (II) nitrate (Cu(NO₃)₂), nickel sulfate (NiSO₄), carbon-based particle dispersants, or other strong light-absorbing reagents.

15. The method of claim 13, wherein the baseline sample is a saturated or near saturated solution.

16. The method of claim 13, wherein the ISARS baseline spectra are used in a wavelength region where the baseline sample's ISARS intensity does not change with a dilution of the saturated sample.

17. A method for calibrating the ISARS spectrophotometer of claim 1, comprising:
acquiring, with the ISARS spectrophotometer, ISARS-based absorbance spectra A_{ISARS}(λ) of a series of calibration samples, wherein the calibration samples comprise a plurality of solutions of molecular chromophores.

18. The method of claim 17, wherein the molecular chromophores are pure light absorbers having no significant scattering activity.

19. The method of claim 17, wherein the molecular chromophores are selected from the group consisting of potassium permanganate (KMnO₄), copper (II) nitrate (Cu(NO₃)₂), nickel sulfate (NiSO₄), and combinations thereof.

20. The method of claim 17, further comprising:
acquiring double-beam UV-vis spectra of the calibration samples, A_{db}(Δ), and curve-fitting the ISARS-based absorbance spectra A_{ISARS}(Δ) to the double-beam UV-vis spectra according to the following equation:
$${A}_{db} ( λ ) = {a}_{3} ( λ ) {( {A}_{ISARS} ( λ ) )}^{3} + {a}_{2} ( λ ) {( {A}_{ISARS} ( λ ) )}^{2} + {a}_{1} ( λ ) {A}_{ISARS} ( λ ) + {a}_{0} ( λ ) .$$

21. A method for decomposing a double-beam UV-vis extinction spectrum, comprising:
acquiring, with a UV-vis spectrophotometer, the double-beam UV-vis extinction spectrum of the sample;
acquiring, with an ISARS spectrophotometer, an ISARS intensity spectrum of the sample;
transmitting the measured double-beam extinction spectrum and the ISARS intensity spectrum to a processor, wherein the processor comprises a non-transitory computer readable medium with instructions executable to:
convert the ISARS intensity spectrum into an ISARS-based absorbance spectrum,
determine an ISARS-based double-beam absorbance spectrum from the ISARS-based absorbance spectrum, and
determine an ISARS-based double-beam scattering extinction spectrum from the ISARS-based double-beam absorbance spectrum and the double-beam UV-vis extinction spectrum.

22. The method of claim 21, wherein the ISARS-based double-beam scattering extinction spectrum is determined by subtracting the ISARS-based double-beam absorbance spectrum from the double-beam UV-vis extinction spectrum.

23. The method of claim 21, wherein the ISARS intensity spectrum is converted by determining a baseline ISARS intensity spectrum and calculating ISARS-based absorbance spectrum according to the following equation:
$${A}_{ISARS} ( λ ) = - log \frac{{I}_{ISARS , sample} ( λ ) - {I}_{ISARS , baseline} ( λ )}{{I}_{ISARS , solvent} ( λ ) - {I}_{ISARS , baseline} ( λ )}$$
where I_{ISARS, sample}(λ) is the ISARS intensity spectrum of the sample, I_{ISARS,baseline}(λ) is the baseline ISARS intensity spectrum, and I_{SARS, solvent}(λ) is an ISARS intensity spectrum of a solvent control.

24. The method of claim 21, wherein the ISARS-based double-beam absorbance spectrum is related to the ISARS-based absorbance spectrum according to the following equation:
$${A}_{db}^{ISARS} ( λ ) = {a}_{3} ( λ ) {( {A}_{ISARS} ( λ ) )}^{3} + {a}_{2} ( λ ) {( {A}_{ISARS} ( λ ) )}^{2} + {a}_{1} ( λ ) {A}_{ISARS} ( λ ) + {a}_{0} ( λ )$$
where
$${A}_{db}^{ISARS}$$
is the ISARS-based double-beam absorbance spectrum, A_{ISARS} is the ISARS-based absorbance spectrum, and a₀, a₁, a₂, and a₃ are polynomial fitting coefficients obtained with ISARS calibration samples.
